(19) United States
(12) Patent Application Publication
(10) Pub. No.: US 2024/0369352 A1
(43) Pub. Date: Nov. 7, 2024

(54) DETERMINING AND RECONSTRUCTING A SHAPE AND A MATERIAL PROPERTY OF AN OBJECT

(71) Applicant: Meta Platforms Technologies, LLC, Menlo Park, CA (US)

(72) Inventors: Salim BOUTAMI, Seattle, WA (US); Mantas ZURAUSKAS, Redmond, WA (US); Scott Charles MCELDOWNEY, Redmond, WA (US)

(73) Assignee: Meta Platforms Technologies, LLC, Menlo Park, CA (US)

(21) Appl. No.: 18/384,660

(22) Filed: Oct. 27, 2023

Related U.S. Application Data
(60) Provisional application No. 63/501,051, filed on May 9, 2023.
(60) Provisional application No. 63/499,081, filed on Apr. 28, 2023.

(51) Int. Cl. G01B 11/25; G01B 11/22; H04N 13/254

(52) U.S. Cl. CPC G01B 11/2536; G01B 11/22; H04N 13/254; G01N 2021/177; G01N 2021/1782; G01N 2021/213; G01N 2021/214; G01N 2021/216; G01N 2201/0635

(57) ABSTRACT

According to examples, a system for implementing structured polarized illumination techniques to determine and reconstruct a shape and a material property of an object is described. The system may include a light source to transmit an original beam of light; a first grating to diffract the original beam of light into a first light beam and a second light beam, a second grating to emit overlapping light beams towards an object, a polarization camera to capture light reflected from the object, and a computer system, comprising a processor and a non-transitory computer-readable storage medium having an executable stored thereon. The processor, when executing the instructions, may cause the system to analyze the light reflected from the object to determine a fringe projection analysis associated with the object, determine a shape of the object; and determine a Mueller matrix to describe material properties of the object.

### PRIORITY

This patent application claims priority to U.S. Provisional Patent Application No. 63/501,051, entitled “Sync Data Across Apparatuses,” filed on May 9, 2023, and U.S. Provisional Patent Application No. 63/499,081, entitled “Determining a Presence of an Ultraviolet (UV) Anti-reflective (AR) Coating on a Substrate,” filed on Apr. 28, 2023.

### TECHNICAL FIELD

This patent application relates generally to display technologies, and more specifically, to implementing structured polarized illumination techniques to determine and reconstruct a shape and a material property of an object.

### BACKGROUND

In augmented reality (AR), virtual reality (VR), and mixed reality (MR) applications, it may often be necessary to identify various aspects of a physical object. Also, in some instances, an object in the physical world may need to be imported into a virtual world (e.g., for a virtual reality (VR) application).

To properly identify an object, a primary aspect of an object that may need to be determined may include a shape of the object. However, conventional methods for determining a shape of an object may come with drawbacks, such as burdens associated with coordinated use of a plurality of cameras and acquisitions times that may be excessive.

In addition, to properly identify an object, another aspect of an object that may need to be determined may be material properties associated with the object. However, conventional methods for deriving material properties of an object may require rotating elements, which may require larger form factors and more space, more power consumption, and may lead to longer acquisition times.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates an arrangement having two gratings, according to an example.

FIG. 2 illustrates an illumination pattern having two-beam interference, according to an example.

FIG. 3 illustrates an arrangement having a Pancharatman-Berry (PB) grating, according to an example.

FIG. 4 illustrates an image of fringes captured from having two Pancharatman-Berry (PB) gratings via a linear polarizer, according to an example.

FIG. 5 illustrates an arrangement for illuminating an object whose shape and material properties are to be determined, according to an example.

FIGS. 6A-6C illustrates features of a polarization camera that may be utilized to implement techniques of structured polarized illumination described herein, according to an example.

FIG. 7 illustrates a plurality of illumination cards having multiple angle of incidence (AOIs), according to an example.

FIGS. 8A-8B illustrates charts of experimental results of a polarization rendering simulation for a white illumination card and a black illumination card, according to an example.

FIGS. 9A-9B illustrate Mueller matrix retrieval results based on a smaller and larger viewing angles (or angles of incidence (AOI)), according to an example.

FIG. 10 illustrates a block diagram of a system for implementing structured polarized illumination techniques to determine and reconstruct a shape and a material property of an object, according to an example.

FIG. 11 illustrates a method for implementing structured polarized illumination techniques to determine and reconstruct a shape and a material property of an object, according to an example.

FIG. 12A illustrates a glass substrate having inward-facing anti-reflective (AR) coatings, according to an example.

FIG. 12B illustrates a glass substrate having an outward-facing anti-reflective (AR) coating, according to an example.

FIG. 12C illustrates a glass substrate wherein anti-reflective (AR) coatings may be facing in different directions, according to an example.

FIG. 13 illustrates providing a solvent on a glass substrate having a visible light anti-reflective (AR) coating, according to an example.

FIG. 14A illustrates providing a solvent on top of a glass substrate where a visible light anti-reflective (AR) coating may further be provided on an opposite side of the glass substrate, according to an example.

FIG. 14B illustrates aspects of light reflectivity associated with providing a solvent on top of a glass substrate where a visible light anti-reflective (AR) coating may be provided on an opposite side of the glass substrate, according to an example.

FIG. 15A illustrates providing a solvent on top of a visible light anti-reflective (AR) coating, which may be provided on top of glass substrate, according to an example.

FIG. 15B illustrates aspects of light reflectivity associated with providing a solvent on top of a visible light anti-reflective (AR) coating, which may be provided on top of glass substrate, according to an example.

FIG. 16 illustrates a chart of reflectiveness characteristics of a range of electromagnetic radiation including visible light and ultraviolet (UV) light ranges, according to an example.

FIG. 17A illustrates a glass substrate with a solvent provided on one side and an ultraviolet (UV) anti-reflective (AR) coating on an opposite side, according to an example.

FIG. 17B illustrates a glass substrate with a solvent provided on one side and an ultraviolet (UV) coating on an opposite side, according to an example.

FIG. 18A illustrates a glass substrate with an ultraviolet (UV) anti-reflective (AR) coating on top having a solvent provided on one side, according to an example.

FIG. 18B illustrates a glass substrate with an ultraviolet (UV) anti-reflective (AR) coating on top having a solvent provided on one side, according to an example.

FIG. 19 illustrates a method for determining a presence of an ultraviolet (UV) anti-reflective (AR) coating on a substrate, according to an example.

FIGS. 20A-20D illustrate various aspects of a polarization grating having a single surface pattern, according to an example.

FIGS. 21A-21C illustrate aspects of fabrication of a plurality of grating layers utilizing a barrier layer, according to an example.

FIGS. 22A-22B illustrate aspects of a plurality of grating layers stacked on top of each other exhibiting independent pitch or orientation, according to an example.

FIG. 23 illustrates a block diagram of a system for stacking multiple deposited anisotropic layers of a polarization grating structure using a barrier layer, according to an example.

FIG. 24 illustrates a method for stacking multiple deposited anisotropic layers of a polarization grating structure using a barrier layer, according to an example.

FIG. 25 illustrates a flow diagram of a method of fabricating a MEMS mirror device having a wire grid quarter wave plate (QWP), according to an example.

FIGS. 26A-26F, respectively, depict components of the MEMS mirror device during various fabrication phases of the MEMS mirror device, according to an example.

FIG. 27 illustrates a schematic diagram of a wearable device having display components positioned to direct light onto a display, in which the display components include a MEMS mirror device having a crystalline silicon wire grid QWP, according to an example.

FIG. 28 illustrates a perspective view of a wearable device, such as a near-eye display, in the form of a pair of smartglasses, glasses, or other similar eyewear, according to an example.

FIG. 29 illustrates a perspective view of a wearable device, in this instance, a head-mounted display device, according to an example.

FIG. 30 illustrates a block diagram of an environment in which an apparatus may send and/or receive data to be synced across multiple apparatuses, in accordance with an example of the present disclosure.

FIGS. 31-32, respectively, illustrate block diagrams of the apparatus depicted in FIG. 30, in accordance with examples of the present disclosure.

FIG. 33 illustrates a block diagram of a system that includes features of the apparatus depicted in FIGS. 30-32, in accordance with an example of the present disclosure.

FIG. 34 illustrates a flow diagram of a method for syncing input data with data on a remote apparatus, according to an example of the present disclosure.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

In augmented reality (AR), virtual reality (VR), and mixed reality (MR) applications, it may often be necessary to determine various aspects of a physical object. For example, in some instances, while a user may be wearing a pair of augmented reality (AR)-enhanced smartglasses, an object may enter the user's field of view (FOV), and it may be relevant to determine, among other things, what the object is, how the object fits into the user's environment, and various information about the object that may be relevant to the user.

In addition, in some instances, an object in the physical world may need to be imported into a virtual world (e.g., for a virtual reality (VR) application). In these cases, it may also be important to determine aspects of an object in order to properly import the object from the physical world to the virtual world. Also, for example in the case of augmented reality (AR), it may also be important to detect and determine aspects of an object in the physical world in order to properly overlay virtual content.

### Determination of a Shape of an Object-Conventional Methods

To properly identify an object, a primary aspect of an object that may need to be determined may include a shape of the object. Typically, a number of conventional methods may be utilized to determine a shape of an object. However, as discussed further below, each of these conventional methods may come with drawbacks.

In some instances, a first method that may be utilized to determine a shape of an object may be stereo depth reconstruction. In some examples, implementation of stereo depth reconstruction may include use of a plurality of cameras to capture a plurality of images, whereby pixels from the plurality of cameras may be matched to retrieve a relative depth based on the positions of the plurality of cameras. However, in some instances, a drawback of utilizing stereo depth reconstruction may be that coordinated use of the plurality of cameras may be burdensome.

Another method that may be utilized to determine a shape of an object may be time of flight. In some examples, implementation of time of flight may include sending light from an illumination source to scan an environment or scene, wherein time of propagation may be recorded at a detector after being returned (e.g., reflected) from an object. In some instances, time of propagation may provide information related to depth and/or distance of an object based on a location of an illumination source and a detector. However, a drawback of utilizing the time of flight method may be that, typically, acquisitions times may be excessive and it may be necessary to scan with respect to a direction of illumination in order to provide scene depth.

Yet another method that may be utilized to determine a shape of an object may be structured illumination via intensity modulation (or variation). In some examples, implementation of structured illumination may include illuminating an object with a predetermined, intensity-structured illumination pattern having fringes (e.g., sinusoidal fringes). Implementation of structured illumination may typically include utilization of a sinusoidal intensity distribution that may vary in one direction and may be uniform in other directions.

In some examples, upon projection of the structured illumination pattern having a plurality of fringes, a deformation of the plurality of fringes may be measured. Specifically, in some examples, a deformation of the plurality of fringes may be proportional to a shape of the illuminated object and relative to a position of illumination source and a corresponding detector.

It may be appreciated that a benefit of utilizing structured illumination may be that only one camera may be necessary, and result may often be achieved via a single iteration. However, a drawback may be that structured illumination may be limited in that during implementation, an object may need to remain stationary. As a result, it may not necessarily be effectively implemented in most augmented reality (AR), mixed reality (MR), and virtual reality (VR) settings, where a user may typically utilize a camera (e.g., on a smartphone) that may be continuously moving. Also, in some instances, another drawback of structured illumination may be that it may not always provide shape-related information to a sufficient resolution.

### Determination of Material Properties of an Object-Conventional Methods

Also, in order to properly identify an object, another aspect of an object that may need to be determined may be material properties associated with the object. In some examples, and often typically, information about material properties of an object may be gathered by determining a Mueller matrix of an object.

In some examples, a Mueller matrix of an object may describe a polarized response (or reflectance) of an object to possible polarized and unpolarized illumination settings, for a number of possible angles of incidence and scattering angles. In some examples, for a given material, a Mueller matrix may depend on incoming and scattering angles with respect to a surface normal.

### Calculation of a Mueller Matrix

In some examples, a Mueller matrix M may be calculated for given incident and scattering angles. In some examples, the Mueller matrix M may be an N×N (e.g., 4×4) matrix. In some examples, a Mueller matrix M may be associated with at least one Stokes vector S. In particular, in some examples, a Stokes vector S may describe a response to a polarized state of light. In some examples, the polarization state of the light may be described as a polarization angle (e.g., zero (0) degrees, forty-five (45) degrees or π/4 degrees, ninety (90) degrees or π/2 degrees, one hundred thirty-five (135) degrees or −π/4 degrees, etc.). In some examples, a Mueller matrix M may be associated with an input Stokes vector Sᵢ and an output Stokes vector Sₒ, wherein the input Stokes vector Sᵢ and an output Stokes vector Sₒ may be determined as follows:
S₀=I₀+I₉₀=I₄₅+I₁₃₅ (wherein S₀ may represent a total intensity of light)
S₁=I₀−I₉₀ (wherein S₁ may represent a linear polarization preference between a zero and ninety-degree axis)
S₂=I₄₅−I₁₃₅ (wherein S₂ may represent a linear polarization preference between a forty-five and one hundred and thirty-five-degree axis)
S₃=I_{RCP}−I_{LCP} (wherein S₃ may represent a circular polarization preference between right circular polarization (RCP) and left circular polarization (LCP) orientations).

So, in some examples, an input Stokes vector Sᵢ may be described as:

Sᵢ=(Si₀;Si₁;Si₂;Si₃)

In some examples, a non-polarized light beam may only have a S₀ component. Also, in some examples, a fully, horizontally-linear polarized light beam may have S₀=S₁. Additionally, in some examples, a fully, vertically-linear polarized light beam may have S₀=−S₁. So, in some examples, an output Stokes vector Sₒ may be described as:

Sₒ=(So₀;So₁;So₂;So₃)

In some examples, characteristics of an input Stokes vector Sᵢ may be predetermined, and upon interaction of illumination with an object, an output Stokes Sₒ vector may be determined as well. In some examples, a Mueller matrix M may be calculated using the input Stokes vector Sᵢ and output Stokes vector Sₒ as follows:

$${S}_{o} = M * {S}_{i}$$

As will be discussed in greater detail below, utilizing this relationship between an input Stokes vector, an output Stokes vector, and a Mueller matrix, the input Stokes vector and the output Stokes vector may be utilized to determine a Mueller matrix that may describe material properties of an object.

### Mueller Matrix Ellipsometry-Conventional Implementation

In some examples, determination of a Mueller matrix may be referred to Mueller matrix ellipsometry. In some examples, implementation of Mueller matrix ellipsometry may include use of at least one rotating polarizer, at least one rotating analyzer, a camera and at least one waveplate located in front of an unpolarized illumination source. In some examples, the rotating analyzer and the at least one waveplate may be located in front of the camera.

In some examples, the at least one rotating polarizer may be utilized to generate various polarization input states with respect to the at least one waveplate located in front of the camera, which may then be analyzed to determine corresponding Mueller matrix elements. In particular, in some examples, the rotating polarizer may be rotated to implement four (4) input Stokes vectors and generate four (4) output Stokes vectors, which may then be used to determine sixteen (16) elements need to generate a Mueller matrix.

However, implementation of Mueller matrix ellipsometry may come with various difficulties and limitations. That is, in some examples, and even using state-of-the-art methods, deriving material properties for an arbitrary (e.g., an object that may not have substantially flat surfaces) may be difficult without knowing a shape of the object. Also, even using state-of-the-art methods, deriving material properties of an object may require rotating elements, which may require larger form factors and more space, more power consumption, and longer acquisition times.

### SUMMARY OF THE INVENTION

Systems and methods as described may implement structured polarized illumination techniques to provide determination and reconstruction of a shape and a material property of an object, along with determination reconstruction of material properties of an object. As used herein, “structured polarized illumination” may include illumination settings and/or characteristics where a polarization state may be spatially varying.

In some examples and as will be discussed further below, the systems and methods may implement a polarization camera that may provide fringe patterns (e.g., via a variation of polarization angles/orientations). In some examples, these fringe patterns may be utilized to determine one or more of shape and material properties information relating to an object.

In some examples, the systems and methods may image an object with a polarization camera that may include wire grids located in front of camera pixels. In some examples, because a polarization state (e.g., rotating along the horizontal axis) prior to reaching camera pixels may be known, the wire grids may only transmit (fully) for a polarization state that may match a particular orientation. In some examples, the camera pixels may be used to determine fringe patterns by converting a polarization orientation into an intensity corresponding to the fringe patterns. It may be appreciated that implementation of the structured polarized illumination techniques described herein may not require varying intensities.

As will be discussed in further detail below, the systems and methods may be directed to virtual reality (VR) and/or augmented reality (AR) applications, where it may be desirable to detect, decipher, characterize, and/or represent (e.g., digitally) an object in located in the physical world. In some examples, the systems and methods may be directed to, among other things, object classification applications, simultaneous localization and mapping (SLAM), and importation and overlay of physical objects into augmented reality (AR) and virtual reality (VR) content.

In some examples, the systems and methods describe may provide various benefits related to implementation as well. As discussed above, in traditional Mueller matrix ellipsometry, it may be necessary to implement multiple input Stokes vectors sequentially in order to gather the necessary components required to determine a Mueller matrix. However, in some examples, the systems and methods described may implement structured polarized illumination, and because a polarization state of the input Stokes vector may be varied (spatially), additional information associated with material properties of an object may be derived with a single implementation (or a “single shot”). Specifically, and as will be discussed further below, structured polarized illumination may enable implementation of a plurality of (varying) polarization phases with one emission, which may provide multiple (shifted) patterns in association with a single base pattern. As a result, greater resolution in determining material properties may be achieved.

Consequently, in some examples, the system and methods may be more compact (e.g., easily integrated into augmented reality (AR) and virtual reality (VR) devices), and my enable faster acquisitions times. In addition, in some examples, the systems and methods may be also applied in dynamic settings (e.g., where an object may be moving), and may require lower power consumption as well.

In some examples, the systems and methods described herein may include a system, comprising a light source to transmit an original beam of light, a first grating to receive and diffract the original beam of light into a first light beam having a first circular polarization and a second light beam having an opposite circular polarization, a second grating to receive the first light beam and the second light beam and emit overlapping light beams towards an object, a polarization camera to capture light reflected from the object, and a computer system. In some examples, the computer system may comprise a processor and a non-transitory computer-readable storage medium having an executable stored thereon, which when executed instructs the processor to: analyze, utilizing a plurality of illumination objects, the light reflected from the object to determine a fringe projection analysis associated with the object, determine, based on the fringe projection analysis associated with the object, a shape of the object, and determine, based on the fringe projection analysis associated with the object, a Mueller matrix to describe material properties of the object. In some examples, the executable when executed further instructs the processor to determine an input Stokes vector associated with the overlapping light beams and determine, based on the fringe projection analysis associated with the object, an output Stokes vector, wherein the Mueller matrix to describe material properties of the object is determined further based on the input Stokes vector and the output Stokes vector. In some examples, the processor and the non-transitory computer-readable storage medium may be comprised in a processing unit. In some examples, the first grating and the second grating are Pancharatman-Berry (PB) gratings and the polarization camera comprises at least one unit cell of pixels comprising at least one pixel, wherein each of the at least one pixel implements a particular wire grid orientation of a polarizer array. In some examples, a first pixel of the at least one pixel implements a wire grid orientation of 0 degrees, a second pixel of the at least one pixel implements a wire grid orientation of π/4 degrees, a third pixel of the at least one pixel implements a wire grid orientation of π/2 degrees, and a fourth pixel of the at least one pixel implements a wire grid orientation of −π/4 degrees. In some examples, the executable when executed further instructs the processor to determine a group of pixels of the polarization camera having a same incident and scattering angle with respect to a surface normal. In some examples, the plurality of illumination objects may comprise one or more illumination cards, including a black illumination card having a smaller angle of incidence (AOI), a black illumination card having a larger angle of incidence (AOI), a white illumination card having the smaller angle of incidence (AOI), and white illumination card having the larger angle of incidence.

In some examples, the systems and methods described herein may include a method for implementing structured polarized illumination techniques to determine and reconstruct a shape and a material property of an object, comprising transmitting an original beam of light, diffracting, utilizing a first grating, the original beam of light into a first light beam having a first circular polarization and a second light beam having an opposite circular polarization, receiving the first light beam and the second light beam at a second grating and emitting overlapping light beams towards the object, capturing, utilizing a polarization camera, light reflected from the object, analyzing, utilizing a plurality of illumination objects, the light reflected from the object to determine a fringe projection analysis associated with the object, determining, based on the fringe projection analysis associated with the object, the shape of the object, and determining, based on the fringe projection analysis associated with the object, a Mueller matrix to describe the material properties of the object.

In some examples, the systems and methods described may include an apparatus, comprising a processor, and a non-transitory computer-readable storage medium having an executable stored thereon, which when executed instructs the processor to determine an input Stokes vector associated with the overlapping light beams from a grating, implement a polarization camera to capture light reflected from an object, analyze, utilizing a plurality of illumination objects, the light reflected from the object to determine a fringe projection analysis associated with the object, determine, based on the fringe projection analysis associated with the object, a shape of the object, determine, based on the fringe projection analysis associated with the object, an output Stokes vector and determine, based on the fringe projection analysis associated with the object, the input Stokes vector, and the output Stokes vector, a Mueller matrix to describe material properties of the object.

### Arrangement of Pancharatman-Berry (PB) Gratings

In some examples, implementing structured polarized illumination may include providing an arrangement of a plurality of Pancharatman-Berry (PB) gratings. In particular, in some examples, two Pancharatman-Berry (PB) gratings may be arranged to create an illumination setting with uniform intensity and linearly polarized light. In addition, the illumination setting may further include an angle of polarization that may be spatially rotating along one axis. It may be appreciated that although examples herein may describe Pancharatman-Berry (PB) gratings, other grating types may be employed as well.

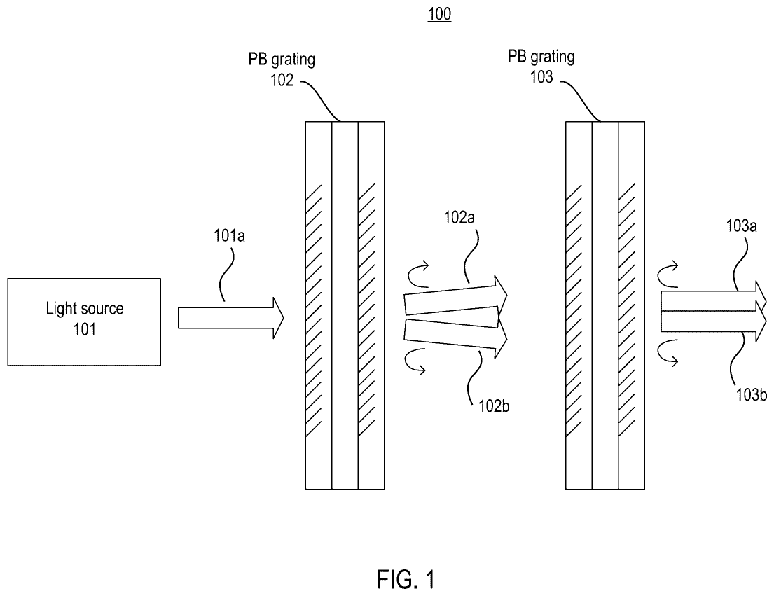

FIG. 1 illustrates an example of an arrangement 100 having two gratings 102-103, according to an example. In some examples, the two gratings 102-103 may be having two Pancharatman-Berry (PB) gratings 102-103. In some examples, an illumination point source (or light source) 101 (e.g., a laser diode) may be used to generate a light beam 101a that may be provided to a first Pancharatman-Berry (PB) grating 101. In some examples, the light beam 101a may be linearly polarized.

In some examples, the first Pancharatman-Berry (PB) grating 102 may be used to take the light beam 101a and create two virtual point sources of light 102a-102b. In some examples, the first Pancharatman-Berry (PB) grating 101 may receive the light beam 101a and may diffract the light beam 101a into two opposite-handed point sources. In particular, the light beam 101a may be diffracted into light from a first point source 102a having a right-handed circular polarization (RCP) (e.g., +1) and light from a second point source 102b having a left-handed circular polarization LCP (e.g., −1). In some examples, light from the first point source 102a and light from the second point source 102b may deviate from each other as they travel toward the second Pancharatman-Berry (PB) grating 103.

In some examples, the second Pancharatman-Berry (PB) grating 103 may receive the two virtual point sources of light 102a-102b, and may emit them (e.g., recombine them) as overlapping light beams 103a-103b, thereby enabling “two-beam interference” and creating an “interference pattern.” In some examples, the Pancharatman-Berry (PB) grating 103 may perform a steering function that may change an angle of a beam to be rotated at exactly an opposite amount of (e.g., to cancel out) a rotation/deviation provided via the first Pancharatman-Berry (PB) grating 102. In some examples, the second Pancharatman-Berry (PB) grating 103 may create an illumination with uniform intensity and fully linearly polarized light, wherein an angle of polarization may be spatially rotating along one axis.

In some examples, to overcome the angle deviation provided, the second Pancharatman-Berry (PB) grating 103 may be similar to the first Pancharatman-Berry (PB) grating 102, but rotated one-hundred eight (180) degrees. That is, in some examples, the second Pancharatman-Berry (PB) grating 103 may diffract the light second time by exactly the opposite amount as the first Pancharatman-Berry (PB) grating 102 so that the exiting beams leave collinearly and overlapping each other. In some examples, the steering function may be provided based on a density of the second Pancharatman-Berry (PB) grating 103.

In some examples, an angle deviation provided via the first Pancharatman-Berry (PB) grating 102 may be predetermined (or “programmed”), and further an extent to which the first point source 102a and the second point source 102b may be collimated (e.g., steered) may be with respect to an angle of rotation. As a result, and in some examples, the collimated beam may exhibit a spatially rotating linear polarization.

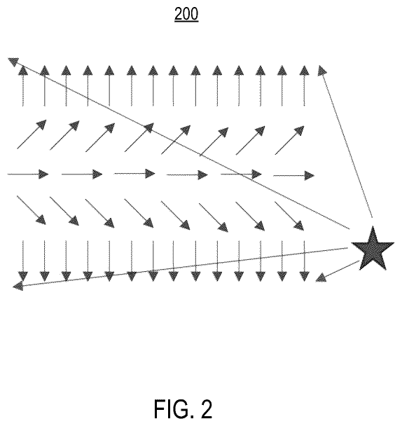

FIG. 2 illustrates an example of an illumination pattern 200 having two-beam interference, according to an example. In some examples, two virtual point sources (e.g., as generated by the second Pancharatman-Berry (PB) grating 103) may have a uniform intensity and may be fully linearly polarized. In some examples, an angle of polarization may be spatially rotating along one axis (or “spatially rotating polarization”).

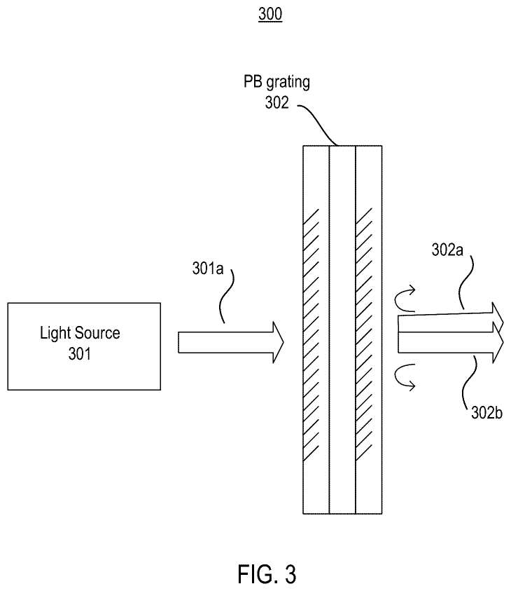

FIG. 3 illustrates an example of an arrangement 300 having a Pancharatman-Berry (PB) grating 302, according to an example. In some examples, the (single) Pancharatman-Berry (PB) grating 302 may be utilized to provide “two-beam interference” and to create an “interference pattern.” Specifically, in some examples, the Pancharatman-Berry (PB) grating 302 may receive a light beam 301a from an illumination source 301 (e.g., a laser diode), and may diffract the light beam 301a into a first point source 302a having a right-handed circular polarization (RCP) (e.g., +1) and a second point source 302b having a left-handed circular polarization LCP (e.g., −1). In some examples, the two-beam interference illustrated in FIG. 3 may be provided by providing the Pancharatman-Berry (PB) grating 302 that may have a lower density. Accordingly, in some examples, the first point source 302a and the second point source 302b may be emitted at a small angle with respect to each other, but may overlap over a specified distance.

### Use of Fringe Projection Analysis

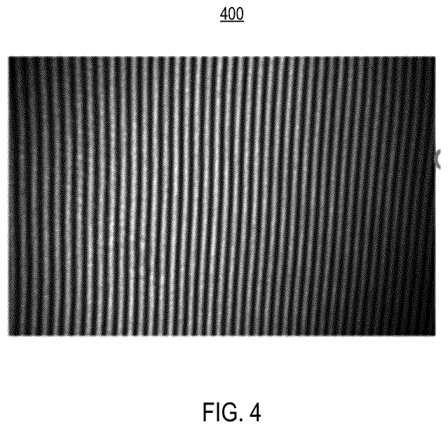

FIG. 4 illustrates an image 400 of fringes captured from having two Pancharatman-Berry (PB) gratings (similar to the example illustrated in FIG. 1) via a linear polarizer, according to an example. In some examples, a polarizer may be provided to mimic wire grid behavior associated with polarization camera pixels (as discussed further below), and to capture fringes 400 that that may result. In particular, in some examples, and as will be discussed further below, the linear polarizer may be utilized to mimic effects of wire grids that may be provided on top of camera pixels of a polarization camera.

In some examples, a linear polarizer may only transmit light where the polarization state may match an orientation of the wire grid. In some examples, the wire grids may be implemented in conjunction with rotating filters. So, in some examples, because a polarization state (e.g., rotating along the horizontal axis) prior to reaching the linear polarizer may be known, the linear polarizer may only transmit (fully) for a polarization state that may match a particular orientation, thereby resulting in the fringes 400. As a result, and as will be discussed further below, in some examples, based on the uniform intensity and the rotating polarization provided by the point sources of light, a set of fringes (e.g., similar to the fringes 400) may be generated for each wire grid/pixel combination of a polarization camera.

### Illumination of an Object and Capture by a Polarization Camera

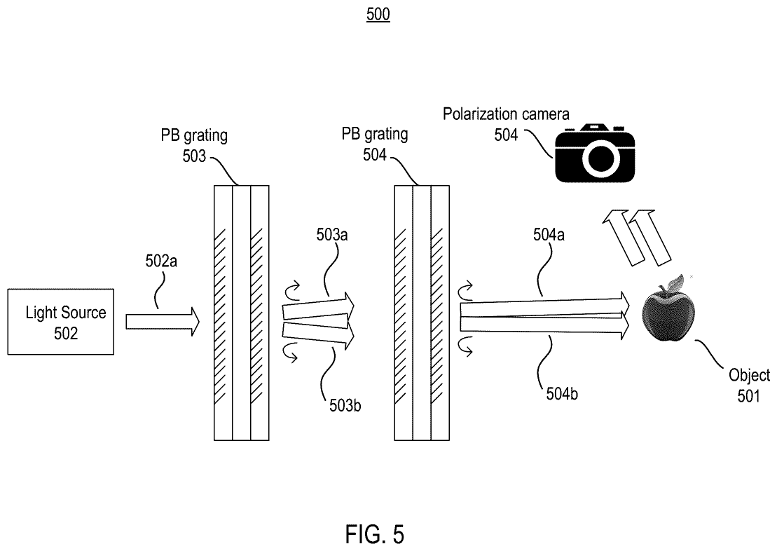

FIG. 5 illustrates an arrangement 500 for illuminating an object 501 whose shape and material properties are to be determined, according to an example. In some examples, similar to the arrangement illustrated in FIG. 1, a light source 502 may direct a light beam 502a (or “original beam”) towards a first Pancharatman-Berry (PB) grating 503. In some examples, the light beam 502a may be linearly polarized. In some examples, the first Pancharatman-Berry (PB) grating 503 may be used to take the light beam 502a and create two virtual point sources (of light) 503a-503b. In some examples, a second Pancharatman-Berry (PB) grating 504 may receive the two virtual point sources of light 503a-503b, and may emit them (e.g., recombine them) as point sources 504a-504b.

In some examples, a first point source 504a and a second point source 504b may emit light that may be collimated and overlapping and may be directed toward to towards the object 501. In some examples, light from the first point source 504a and the second point source 504b may display spatially rotating, linear polarization (as described above). In some examples, upon reflection from the object 501, the first point source 504a and the second point source 504b may be directed towards and captured by a polarization camera 505.

In some examples, a Stokes vector, such as an input Stokes vector, may be calculated as a function of intensity. Specifically, in some examples, intensity of light beam, such as the collimated, overlapping light beams emanating from the (virtual) point sources 504a-504b described above, may be described as:

$${I}_{G θ} = \frac{{S}_{0}}{2} + \frac{{S}_{1} cos ( 2 θ )}{2} + \frac{{S}_{1} sin ( 2 θ )}{2}$$

In some examples, based on the intensity provided above, a Stokes vector S (e.g., an input Stokes vector) may be represented as follows:

$$S = ( \begin{matrix}{S}_{0} \\ {S}_{1} \\ {S}_{2}\end{matrix} ) = ( \begin{matrix}{I}_{0} + {I}_{π / 2} = {I}_{π / 4} + {I}_{- π / 4} \\ {I}_{0} - {I}_{π / 2} \\ {I}_{π / 4} - {I}_{- π / 4}\end{matrix} )$$

In some examples, for the Stokes vector S, an intensity component S₀ may be uniform (equal to one), and S₁ and S₂ may be sinusoidal functions that may vary based on a rotation of a polarization angle. In some examples, S₀ may represent a total light intensity that may be based on intensity of four pixels (e.g., each having a different theta angle 0, π/4, π/2, and −π/4). In some examples, S₁ may represent how light may be horizontally (+1) or vertically polarized (−1), and S₂ may represent how the light is polarized at (at π/4) or (at −π/4).

### Aspects of a Polarization Camera

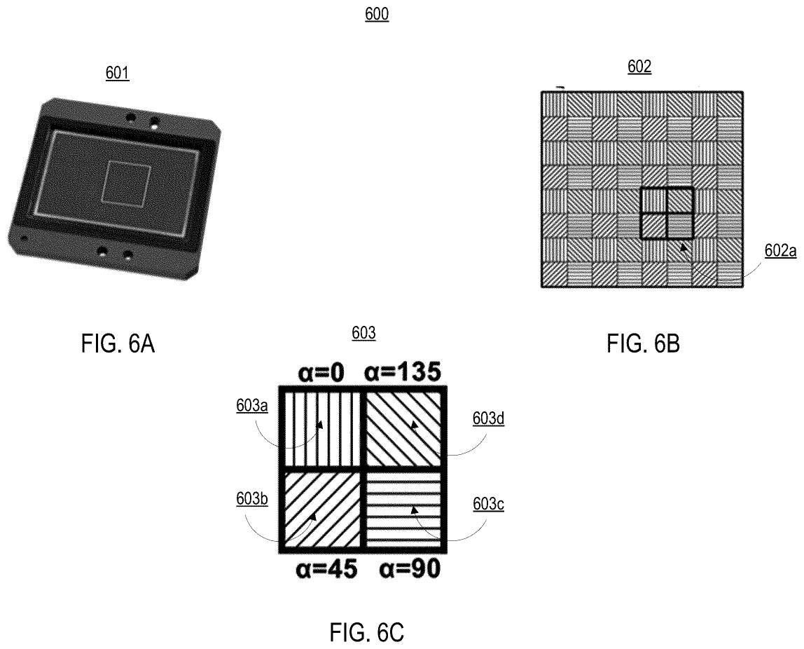

FIGS. 6A-6C illustrates features 600 of a polarization camera (e.g., the polarization camera 505) that may be utilized to implement techniques of structured polarized illumination described herein, according to an example. FIG. 6A illustrates an example of a camera sensor 601 that may operate in associated with a polarization camera. FIG. 6B illustrates a polarizer array 602 that may be matched to detector pixels on a polarization camera (e.g., the polarization camera 503). In some examples, the polarization camera may include a unit cell 602a (or also a “super-pixel” 602a), which may each be composed of four (4) pixels. In some examples, each of the four (4) pixels may have a varied wire grid orientation. In some examples, each wire grid associated with each of the four (4) pixels may serve as a polarizing element.

FIG. 6C illustrates an example of a super-pixel 603 wherein a first (e.g., top left) pixel 603a may have a wire grid orientation α=0 degrees, a second (e.g., bottom left) pixel 603b may have a wire grid orientation α=45 (or π/4) degrees, a third (e.g., bottom right) pixel 603c may have a wire grid orientation α=90 (or π/2) degrees, and a fourth (e.g., top right) pixel 603d may have a wire grid orientation α=135 (or −π/4) degrees. In some examples, each of the pixels 603a-d may transmit only light where a polarization may be matching a corresponding wire grid orientation. In some examples, this may cause each of the pixels 603a-d to produce corresponding fringes (e.g., similar to the fringes illustrated in FIG. 4), which may be shifted proportionally according to a (predefined) structured illumination period.

### Specular and Diffuse Processes

In some examples, to implement structured polarized illumination, light reflected from an object may be imaged on to a plurality of illumination objects (e.g., illumination cards). In some examples, an “illumination object” may include any object that may have a known shape and material properties, and may be utilized to determine and reconstruct shape and material properties of (target) object having unknown shape and material properties. One example of such an illumination object may include an illumination card.

It may be appreciated that, in some instances, reflection of light may involve a “specular” reflection process, wherein light may be (immediately) reflected on a surface of an object. In some examples, this process may involve higher reflectiveness, and may be associated with a higher degree of polarization.

It may be appreciated that any objects may exhibit specular characteristics (e.g., direct reflection), wherein the may be associated with a higher degree of polarization, but a lesser intensity. In such instances, the transmitted light may be substantially absorbed by darker objects, while the transmitted light may not fully absorb the transmitted light and some of the transmitted light may be reflected back after some amount of depolarization. In some instances, this may be referred to as the “diffuse” process. In some instances, light may be partially absorbed by the surface of the object, and then reflected back (e.g., due to scattering). In some examples, this process may include lesser reflectiveness (e.g., the light may be absorbed), and may be associated with a lower degree of polarization. In some instances, due to the diffuse process, an intensity of reflected light may increase, but it may also be that a degree of polarization may decrease because of the (aforementioned) depolarization inside the object (during absorption).

Accordingly, it may be appreciated that objects that are bright (e.g., object that display more light contribution) may exhibit both specular and diffuse characteristics. Moreover, objects that are bright may often maintain a higher degree of polarization. On the other hand, in some examples, objects that are dark (e.g., light is not reflected back) may only display specular characteristics, but minimal diffuse characteristics. Also, objects that are dark may exhibit lower or minimal polarization, since the light may often be depolarized to an extent while inside the object (during absorption).

In some examples, a pair of the plurality of illumination cards may be white, and may have a (predetermined) controlled roughness. In particular, in some examples, a first white illumination card of the pair of white illumination cards may be directed to a smaller angle of incidence (AOI), while a second white illumination card of the pair of white illumination cards may be directed to a larger angle of incidence (AOI). In some examples, a pair of the plurality of white illumination cards may be said to have specular and diffuse characteristics. It may be appreciated that while in some examples at least one illumination card may be utilized (e.g., to determine and reconstruct and object's shape and material properties), in other examples use of an illumination card may not be necessary at all.

It may be appreciated that, in some examples, a plurality of illumination cards may be and/or are to be replaced by any object to be reconstructed. That is, in some examples, a plurality of illumination cards may be utilized to calibrate a system directed to determining and reconstructing a shape and a material property of an object, since a shape and material properties of the plurality of illumination cards may be known. However, it should be appreciated that use of the plurality of illumination cards may not be required to determine and reconstruct a shape and a material property of an object, as described herein.

So, in some examples, a pair of the plurality of cards may be black, and may have a (predetermined) controlled roughness. In particular, in some examples, a first black illumination card of the pair of black illumination cards may be directed to a small angle of incidence (AOI), while a second black illumination card of the pair of black illumination cards may be directed to a larger angle of incidence (AOI). In some examples, a pair of the plurality of black illumination cards may be said to have specular characteristics, but minimal diffuse characteristics.

### Implementation of Illumination Cards (Black and White)

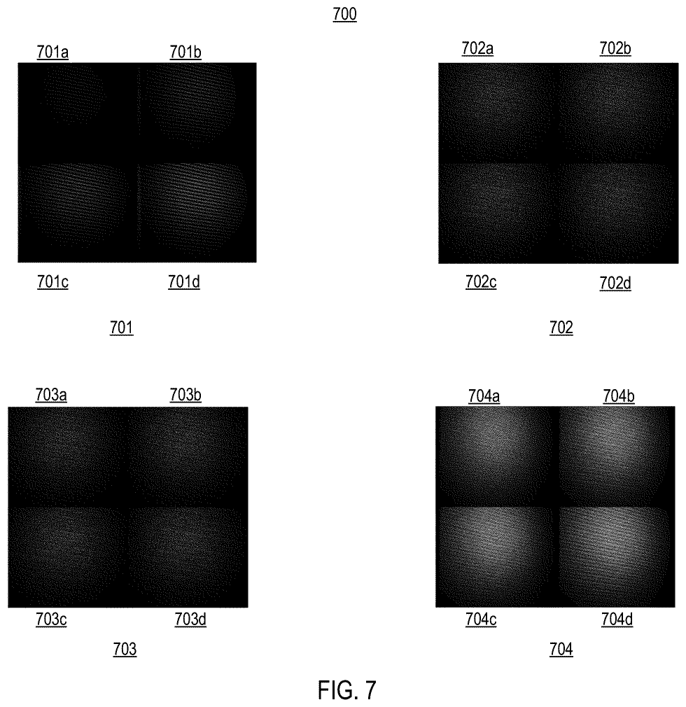

FIG. 7 illustrates a plurality of illumination cards 700 having multiple angle of incidence (AOIs), according to an example. Specifically, FIG. 7 illustrates a black illumination card 701 having an angle of incidence (AOI) of five (5) degrees (e.g., with respect to a surface normal), a black illumination card 702 having an angle of incidence (AOI) of forty (40) degrees (e.g., with respect to a surface normal). Also, FIG. 7 illustrates a white illumination card 703 having an angle of incidence (AOI) of five (5) degrees (e.g., with respect to a surface normal), and white illumination card 704 having an angle of incidence (AOI) of forty (40) degrees (e.g., with respect to a surface normal).

In some examples, at an angle of incidence (AOI) of five (5) degrees, the black illumination card 701 may provide a first image 701a, a second image 701b, a third image 701c, and a fourth image 701d. In some examples, each of the images 701a-701d may also be referred to as “quadrants.” Also, in some examples, at an angle of incidence (AOI) of forty (40) degrees, the black illumination card 702 may provide a first image 702a, a second image 702b, a third image 702c, and a fourth image 702d.

In some examples, at an angle of incidence (AOI) of five (5) degrees, the white illumination card 703 may provide a first image 703a, a second image 703b, a third image 703c, and a fourth image 703d. In some examples, each of the images 703a-703d may also be referred to as “quadrants.” Also, in some examples, at an angle of incidence (AOI) of forty (40) degrees, the black illumination card 704 may provide a first image 704a, a second image 704b, a third image 704c, and a fourth image 704d.

In some examples, each of the images (or quadrants) on the black illumination cards 701-702 and the images (or quadrants) on the white illumination cards 703-704 may correspond to a pixel of a super-pixel (e.g., the super-pixel 603 in FIG. 6C) on a polarization camera (e.g., the polarization camera 505 in FIG. 5). So, in some examples, the first image 701a of the black illumination card 701 may correspond to a top left pixel of a super-pixel, the second image 701b may correspond to a top right pixel of the super-pixel, and so on.

In some examples, and as will be discussed further below, the plurality of illumination cards 700 may be utilized to analyze the light reflected from an object to determine a “fringe projection analysis” associated with the object. So, as illustrated in FIG. 7, a black illumination card may typically exhibit a greater contrast in fringe than a white illumination card. In some examples, this may be because, for the reasons described above, that a white illumination card may typically be more diffuse than a black illumination card. So, in the case of a white illumination card, because much of the light may be diffused, the light may be less or minimally polarized, and therefore may travel through any wire grid having any orientation. That is, in some examples, when the light may be minimally polarized or even fully depolarized (e.g., for a white illumination card), the wire grid may provide uniform transmission at any polarization angle.

In some examples, for a white illumination card where the light may be minimally polarized or fully depolarized, a fully homogenized image may be produced. So, in some examples, if the light may be minimally polarized fully depolarized, a fully homogenized image for all four quadrants may appear where a contrast may be lower and fringes may be relatively compressed. As a result, in some examples, a white illumination card may depolarize light more, and since (after reflection) the polarization of the light from the white illumination card may be lower, the unpolarized light when reaching a wire grid may provide more unpolarized light to a pixel. In some instances, this may create an offset that may degrade a degree of contrast in the fringes.

So, in some examples, where a polarization orientation may match an orientation of the wire grid, it may lead to full or nearly full transmission with minimal contrast. However, when a polarization orientation may be orthogonal to an orientation of the wire grid, it may lead to minimal or no transmission, resulting in a sharp (er) contrast.

### Determination and Reconstruction of a Shape of an Object

It may be appreciated that, in some examples, an object may produce a different reflections based on an input polarization state of projected light. In some examples, fringes produced by the reflection may be based on a polarization state that may be changing, which may produce a (corresponding) contrast in the fringes.

In some examples, a plurality of illumination cards having multiple angle of incidences (e.g., as illustrated in FIG. 7) may be utilized to reconstruct a shape of an object. In particular, by utilizing a projection of fringes (as discussed above with respect to structured illumination), a shape of an object may be determined.

Also, in some examples and as discussed above, structured illumination may require utilizing a plurality (e.g., four) of separate projections at varying intensities. However, in implementing structured polarized illumination, because the polarization states may be varied (e.g., shifted by a quarter of a period, as discussed above) in a single shot to generate a plurality of images (e.g., images 701a-701d in FIG. 7), these images having shifted patterns with associated distinct fringes may be utilized to reconstruct a shape of an object (e.g., in a similar manner to that of structured illumination).

In some examples, each image associated with a pixel of a super-pixel may exhibit a distinct shifted fringes. In some examples, an object will provide a different reflection based on an input polarization state that may be varying (as discussed above).

In addition, in some examples, each pixel of a super-pixel may exhibit a distinct fringes contrast based on a varying input polarization state. Specifically, along these fringes, the input polarization state may be changing (or shifting), resulting in a contrast between the fringes.

Also, and as discussed above, in some examples, after reflection on the object, the returned light may see its polarization state change, which may correspond to these shifted fringes. In some examples, this may also further provide a contrast in the fringes that may be utilized to determine and reconstruct a shape of an object. In some examples, these shifted fringes may improve resolution in a process shape reconstruction, for example when compared to a process that may utilize only one set of fringes.

### Determination and Reconstruction of Material Properties of an Object

In some examples, it may be appreciated that a shifting of fringes and/or a contrast in fringes may be (also) based on material properties of an object. As a result, it may be appreciated that, in some examples, based on (among other things) a known polarization state variation, a shift in fringes, and a contrast in the (shifted) fringes, material properties of an object may be determined.

In particular, in some examples, fringes may vary more at larger angles of incidence (AOI) for a black illumination card. In some examples, this may be a result of the Brewster's Law. For a larger angle of incidence (AOI), an s polarization may be reflected more than a p polarization. In some instances, this may be because certain wire grid orientations may be more suited to s polarization detection, and thus may have produce higher maximum fringe intensities.

Referring back to FIG. 7, for the black illumination card 701 (e.g., at five (5) degrees angle of incidence) and for the white illumination card 703 (e.g., at five (5) degrees angle of incidence), it may appear that fringes may be shifted but the images may exhibit similar contrast.

However, for the black illumination card 702 (e.g., at forty (40) degrees angle of incidence) and for the white illumination card 704 (e.g., at forty (40) degrees angle of incidence), it may appear that fringes may be shifted but the contrast exhibited by images may differ significantly. In some instances, this may be a result of the Brewster's Law, wherein at a larger angle of incidence (AOI), there may be a polarization state that may be highly reflective and another polarization state that may be less reflective. As a result, for one wire grid, there may be fringes that may be exhibited, but another wire grid, the fringes may be compressed.

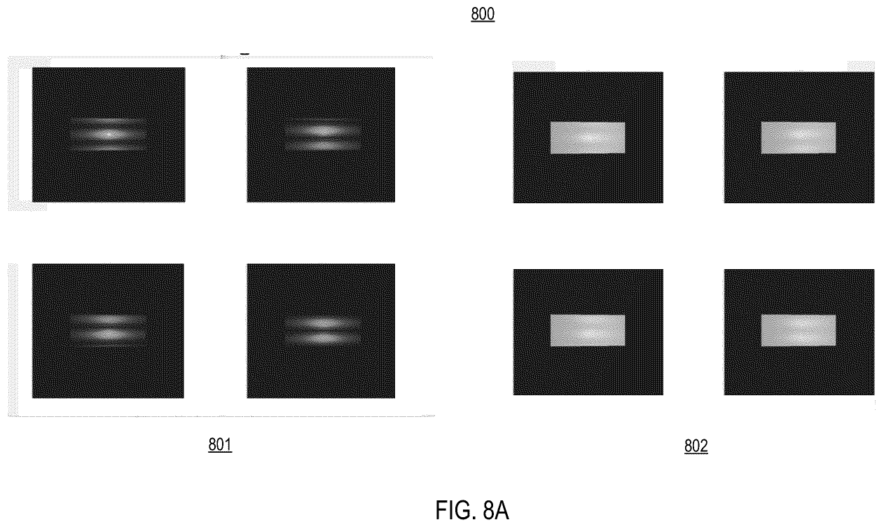

FIGS. 8A-8B illustrates charts of experimental results of a polarization rendering simulation for a white illumination card and a black illumination card utilized in FIG. 7, according to an example. Specifically, FIG. 8A illustrates a rendering of the black illumination card 801 and the white illumination card 802 for a smaller angle of incidence (e.g. five (5) degrees). Also, FIG. 8B illustrates a rendering of the black illumination card 811 and the white illumination card 812 for a larger angle of incidence (e.g. forty (40) degrees). In some examples, the four images may represent four (4) intensities (e.g., I₀, I_{π/4}, I_{π/2}, and I_{-π/4}) that may be associated with pixels of a super-pixel having (corresponding) wire grid orientations (e.g., 0, π/4, π/2, and −π/4).

It should be noted that, in some examples, the black illumination card may exhibit a rotating angle of linear polarization (AOLP) after reflection, whereas the white illumination card, which may (often) be more depolarized, may show a more constant angle of linear polarization (AOLP).

Also, in some examples, the black illumination card may exhibit more fringes, because the white illumination card may be more depolarized. Furthermore, in some examples, for a larger angle of incidence (AOI), the black illumination card may exhibit a significant difference in fringe construction, which may not be present in the case of the smaller angle of incidence (AOI).

### Use of Fringe Information to Determine an Output Stokes Vector

As discussed above, in some examples, a Stokes vector, such as an output Stokes vector S_{camera} (or Sₒᵤₜₚᵤₜ) to be determined in implementation of structured polarized illumination techniques described herein, may be calculated as a function of intensity. Specifically, in some examples, intensity of light having an angle theta (θ) (e.g., as exhibited by a pixel located below a wire grid filter), may be described as:

$${I}_{G θ} = \frac{{S}_{0}}{2} + \frac{{S}_{1} cos ( 2 θ )}{2} + \frac{{S}_{1} sin ( 2 θ )}{2}$$

As discussed above, in some examples, a super-pixel may include four pixels, wherein each pixel may be associated with a different theta (θ) angle (e.g., 0, π/4, π/2, and −π/4). As also discussed above, in some examples, a quadrant image (e.g., the quadrant images illustrated in FIG. 7) may be associated with one of the four pixels, wherein fringes may be associated with an intensity for each of the pixels. Specifically, in some examples, based on the intensity (/) determined for the various angles (θ), a Stokes vector (e.g., an output Stokes vector S_{camera}) may be represented by three components S₀, S₁, and S₂, and may be determined as follows:

$$S = ( \begin{matrix}{S}_{0} \\ {S}_{1} \\ {S}_{2}\end{matrix} ) = ( \begin{matrix}{I}_{0} + {I}_{π / 2} = {I}_{π / 4} + {I}_{- π / 4} \\ {I}_{0} - {I}_{π / 2} \\ {I}_{π / 4} - {I}_{- π / 4}\end{matrix} )$$

In some examples, S₀ may represent a total light intensity that may be based on intensity of four pixels (e.g., each having a different theta angle 0, π/4, π/2, and −π/4) of a super-pixel. In some examples, S₁ may represent how light may be horizontally (+1) or vertically polarized (−1), and S₂ may represent how the light is polarized at (at +45) or (at −45).

It may be appreciated that the equations for S₀, S₁, and S₂ may be rewritten as follows:

$${S}_{0} = ( {I}_{0} + {I}_{π / 4} + {I}_{π / 2} + {I}_{- π / 4} ) / 4$$

$${S}_{1} = {I}_{0} - {I}_{π / 2}$$

$${S}_{2} = {I}_{π / 4} - {I}_{- π / 4}$$

In some examples, based on the relationships indicated above, an intensity of each pixel (e.g., I₀, I_{π/4}, I_{π/2}, and I_{-π/4}) may be provided with respect to a Stokes vector component (e.g., S₀, S₁, and S₂). Specifically, in some examples, where four (4) wire grid polarizers may be implemented having theta (θ) angles of 0, π/4, π/2, and −π/4, their intensities as functions Stokes components S₀, S₁, and S₂ may be rewritten as:

$${I}_{0} = ( {S}_{0} + {S}_{1} ) / 2$$

$${I}_{π / 4} = ( {S}_{0} + {S}_{2} ) / 2$$

$${I}_{π / 2} = ( {S}_{0} - {S}_{1} ) / 2$$

$${I}_{- π / 4} = ( {S}_{0} - {S}_{2} ) / 2$$

Determination of a Mueller Matrix Associated with Material Properties-First Approach

In some examples, implementing structured polarized illumination techniques as described herein may include determining a Mueller matrix for an object. As discussed above, in some examples the Mueller matrix for the object may be used to describe material properties of the object. Specifically, in some examples, structured polarized illumination techniques as described herein may be utilized to provide multiple, different (incident) polarization states that may be used to determine material properties of the object.

In some examples, a Mueller matrix may be determined with respect to an incident angle and a scattering angle (also referred to as “outgoing angle”). In some examples, and as discussed further below, fringes information associated with an object and a shape of the object may be utilized to determine Mueller matrix elements for the object for a range of incident angles and scattering angles with respect to a surface normal. In some examples, for an object of arbitrary shape, projection of fringes may be utilized to determine a shape of (along with associated depths for) the object, which may then be used to determine a map of surface normals that may be associated with the object.

According to examples, and as will be discussed further below, a Mueller matrix for an object may be determined in multiple ways. In a first method, three parameters (e.g., associated with an incident angle and a scattering angle) may be utilized to determine a Mueller matrix. In some examples, the three parameters may include theta_i (or θᵢ), which may represent a zenith incident angle with respect to a normal, theta_o (or θₒ), which may represent a zenith viewing angle, and phi (ϕ), which may represent an azimuth difference between incident and scattered rays. As will be discussed further below, in some examples, these three parameters may be utilized to group similarly situated pixels.

In some examples, utilizing these parameters, and based on a shape of an object, a position of an illumination source and a position of a camera (e.g., a polarization camera), a Mueller matrix for an object may be determined for a given incident and scattering angle. That is, in some instances, a particular Mueller matrix may be determined for each pair of incident angle and scattering angle.

In some examples, based on a position of an illumination source and a position of a camera, pixels that may share a same incident and scattering angle with respect to a surface normal may be determined. It should be appreciated that because a surface normal may be changing over a surface of an object, there may be different (corresponding) pixels for which an incident angle and scattering angle may be same.

In some examples, upon determining at least one pixel (e.g., three (3) independent pixels) that may share a same incident and scattering angle with respect to a surface normal, a rotation matrix technique (e.g., rotation from source to surface normal coordinates, rotation from surface normal to camera coordinates, etc.) may be implemented to generate a linear system that may include Mueller Matrix elements intrinsic to material.

In some examples, the input Stokes vector may be referred to as S_{source}, and may be determined according to predetermined implementation of gratings, as discussed above. Also, in some examples, the output Stokes vector may be referred to as S_{camera}, and may be determined based on the fringes projection analysis discussed above. In some examples, a Mueller matrix may be referred to as M_{object}, and may be represented by the following equation:

$$\text{?} \text{?} ( \text{?} ) = \text{?} ( \text{?} ) \text{?} M \text{?} \text{?} \text{?} \text{?} ( \text{?} ) \text{?} \text{?} \text{?} ( \text{?} \text{?} ) \text{?} \text{?} \text{?} ( \text{?} )$$

$$\text{?} \text{indicates text missing or illegible when filed}$$

In some examples, incorporating one or more rotation matrixes, this equation may be rewritten as:

$$\text{?} \text{?} \text{?} \text{?} \text{?} = \text{?} \text{?} \text{?} \text{?} \text{?}$$

$$( \begin{matrix}{m}_{00} & {m}_{01} & {m}_{02} \\ {m}_{10} & {m}_{11} & {m}_{12} \\ {m}_{20} & {m}_{21} & {m}_{22}\end{matrix} ) \text{?} \text{?} ( \begin{matrix}s {\text{?}}_{10} \\ s {\text{?}}_{11} \\ s {\text{?}}_{12}\end{matrix} ) \text{?} ( \begin{matrix}s {\text{?}}_{00} \\ s {\text{?}}_{01} \\ s {\text{?}}_{02}\end{matrix} )$$

$$\text{?} \text{indicates text missing or illegible when filed}$$

In some examples, where multiple (e.g., three) independent pixels that may share a same incident and scattering angle (also known as “classification”) may grouped to create a group (or groups) of pixels where, within each of these groups, the incident and scattering angles may be similar or same with respect to a surface normal. In some examples, the classification may provide a matrix that includes the pixels in this group. In some examples, where a group may include three pixels having a same incident and scattering angle with respect to a surface normal (e.g., based on θᵢ, θₒ, and ϕ), a classification may be represented as follows:

$$\text{?} ↕ ( {{{0 < \vert \text{?} - \text{?} \vert < d \text{?} \text{?}}_{□}}^{□}}^{⟷} ) \text{?} \text{?} \text{?} ( {{\vert \text{?} - \text{?} \vert < d \text{?} \text{?}}^{□}}_{□} ) \text{?} \text{?} ( {{0 < \vert \text{?} - \text{?} \vert < \text{?} \text{?}}^{□}}_{□} ) \text{?} ( \begin{matrix}0 & \text{?} & 1 & 1 \\ 1 \text{?} & 0 \text{?} & \text{?} & 1 \text{?} \\ 1 & 1 & \text{?} & 0\end{matrix} )$$

$$\text{?} \text{indicates text missing or illegible when filed}$$

In some examples, components of a Mueller matrix may be determined for a group (e.g., three) of pixels where the incident and scattering angles may be similar or same with respect to a surface normal:

$$( \begin{matrix}\text{?} & \text{?} & \text{?} & 0 & 0 & 0 & 0 & 0 & 0 \\ 0 & 0 & 0 & \text{?} & \text{?} & \text{?} & 0 & 0 & 0 \\ 0 & 0 & 0 & 0 & 0 & 0 & \text{?} & \text{?} & \text{?} \\ \text{?} & \text{?} & \text{?} & 0 & 0 & 0 & 0 & 0 & 0 \\ 0 & 0 & 0 & \text{?} & \text{?} & \text{?} & 0 & 0 & 0 \\ 0 & 0 & 0 & 0 & 0 & 0 & \text{?} & \text{?} & \text{?} \\ \text{?} & \text{?} & \text{?} & 0 & 0 & 0 & 0 & 0 & 0 \\ 0 & 0 & 0 & \text{?} & \text{?} & \text{?} & 0 & 0 & 0 \\ 0 & 0 & 0 & 0 & 0 & 0 & \text{?} & \text{?} & \text{?}\end{matrix} ) * {( \begin{matrix}m \text{?} \\ m \text{?} \\ m \text{?} \\ m \text{?} \\ m \text{?} \\ m \text{?} \\ m \text{?} \\ m \text{?} \\ m \text{?}\end{matrix} )}_{\text{?}} = ( \begin{matrix}\text{?} \\ \text{?} \\ \text{?} \\ \text{?} \\ \text{?} \\ \text{?} \\ \text{?} \\ \text{?} \\ \text{?}\end{matrix} )$$

$$\text{?} \text{indicates text missing or illegible when filed}$$

In some examples, and as indicated above, the Mueller matrix may be expressed as a vector with the following components (m₀₀, m₀₁, m₀₂, m₁₀, m₁₁, m₁₂, m₂₀, m₂₁, m₂₂). In the above example, each pixel where the incident and scattering angles may be similar or same may include three components a, b, c that may correspond to the parameters discussed above (e.g., based on θᵢ, θₒ, and ϕ). In the example above, the three components for each of the three pixels may provide the nine elements in the Mueller matrix in vector form. However, it may be appreciated that the Mueller matrix may be calculated in this manner with more than three pixels as well.

Furthermore, it may be appreciated that, in some examples, the structured polarized illumination techniques described herein to generate a Mueller matrix for an object may not provide access to a fully polarized bi-directional reflectance function (pBRDF). In some examples, a fully polarized bi-directional reflectance function (pBRDF) may provide Mueller matrices for all possible incoming and scattering angled rays. Instead, in some examples, the structured polarized illumination techniques may provide access to an angle range that may be offered by a particular setting (e.g., a location of camera, a location of illumination source, etc.) and a particular object shape.

Determination of a Mueller Matrix Associated with Material Properties-Second Approach

As discussed above, a second approach to implementing structured polarized illumination to determine a Mueller matrix for an object may be implemented as well. In some examples, the second approach may include utilizing two parameters may be implemented to represent a relationship between an incident angle and a scattering angle. In some examples, the two parameters may include a “halfway vector”, which may represent an average of incident and an outgoing vector, and a “difference angle”, which may represent an angle between an incident vector and a halfway vector. In some examples, these three parameters may be utilized to group similarly situated pixels. In some examples, the halfway vector may be represented as:

$$h = \frac{w \text{?} + w \text{?}}{‖ w \text{?} + w \text{?} ‖}$$

$$θ \text{?} = a cos [ \text{?} ]$$

$$ϕ \text{?} = a cos [ \frac{\text{?}}{‖ \text{?} - cos θ \text{?} n ‖} ]$$

$$\text{?} \text{indicates text missing or illegible when filed}$$

In some examples, the difference angle may be represented as:

$$d = R \text{?} * R \text{?} * w \text{?}$$

$${θ}_{d} = a cos [ n \text{?} d ]$$

$${ϕ}_{d} = a cos [ \frac{t \text{?} d}{‖ d - cos θ \text{?} n ‖} ]$$

$$\text{?} \text{indicates text missing or illegible when filed}$$

It may be appreciated that, in some examples, any representation basis for a polarized bi-directional reflectance function (pBRDF) may be utilized for the structured polarized illumination techniques described herein. Indeed, in some examples, this may include grouping pixels (e.g., pixels sharing same angles in this basis) before inversing a linear system for a Mueller matrix.

As discussed above, in some examples, structured polarized illumination techniques as described herein may include spatially varying a polarization state of the input Stokes vector with a single implementation (or a “single shot”). Furthermore, it may be appreciated that implementation of techniques for structured polarized illumination to determine shape and material properties of an object may be extended to more than one sinusoidal modulation component present for an illumination pattern at different angles. As a result, in some examples, the techniques for structured polarized illumination may extend to several projection systems.

In addition, it may be appreciated that wavelength multiplexing may be added to increase robustness of an approach (e.g., one projector in red, one in green, one in blue). In some examples, this may be utilized to recover more material information as additional variations may be implemented based on input wavelength(s).

Furthermore, in some examples, a combination of liquid crystal (LC) elements and switchable printed board (PB) elements may be used to switch between structured polarized light and linearly (or circularly) polarized light (e.g., to implement a dynamic pattern) in every second frame to capture both a higher quality measurement that may capture a Mueller matrix at lower resolution and a reduced quality image at higher resolution.

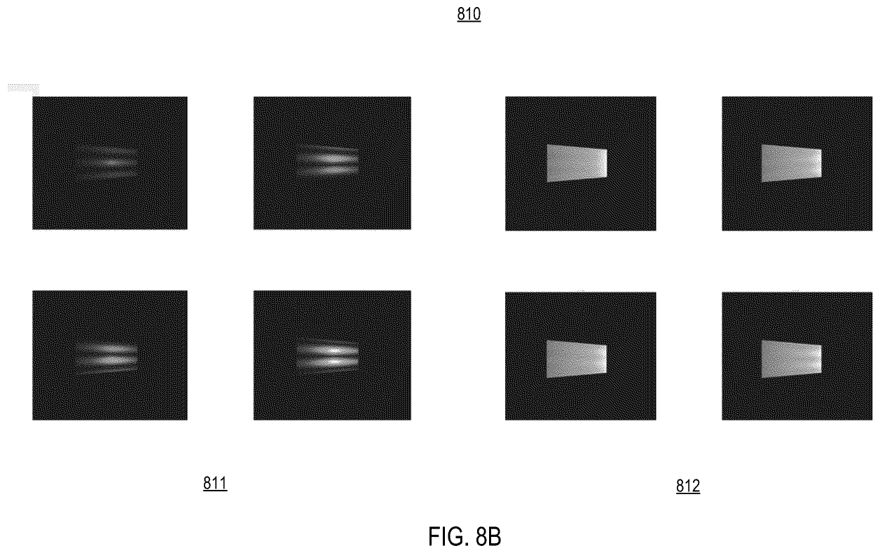

FIGS. 9A-9B illustrate Mueller matrix retrieval results based on a smaller and larger viewing angles (or angles of incidence (AOI)), according to an example. Specifically, FIG. 9A illustrates Mueller matrix retrieval results 900, 910 based on a smaller viewing angle (or angle of incidence (AOI)), according to an example. In some examples, the smaller viewing angle may be five (5) degrees. In some examples, as discussed above, utilizing structured polarized illumination techniques as described herein, a Mueller matrix for an object may be recovered. In some examples, the Mueller matrix may be recovered using, among other things, polarized images from structured polarized illumination, a shape of the object, and a location of an illumination source and a location of a camera (e.g., a polarization camera).

In FIG. 9A, the left images 901 may represent reconstructed results, while the right images 902 may represent an analytical ground truth. In some examples, a diffuse card where an angle of incidence is five (5) degrees may be simulated. FIG. 9B illustrates Mueller matrix retrieval results based on a larger viewing angle (or angle of incidence (AOI)), according to an example. In some examples, the larger viewing angle may be fifty-five (55) degrees. As illustrated in FIG. 9B, the left images 911 may represent reconstructed results, while the right images 912 may represent analytical ground truth. It may be appreciated that, in some examples, polarization for a diffuse material may appear at large viewing angles.

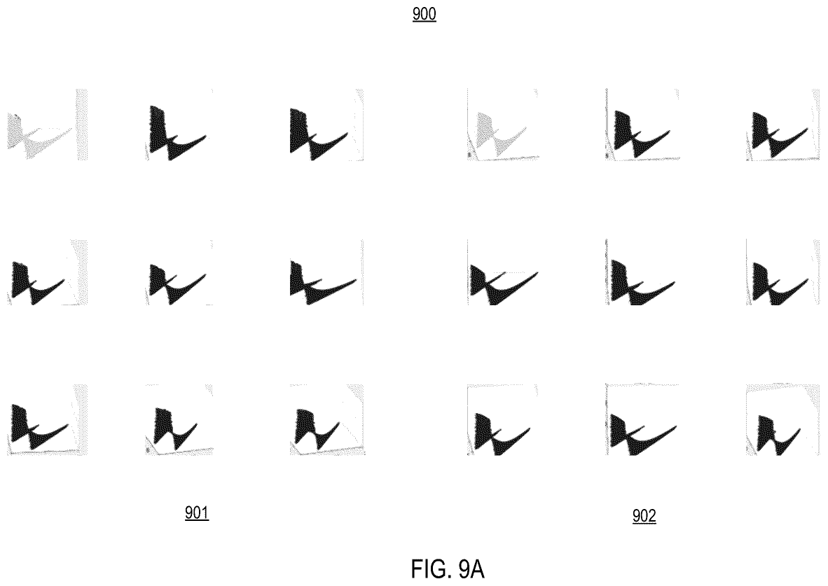

Reference is now made to FIG. 10. FIG. 10 illustrates a block diagram of a system 1000 for implementing structured polarized illumination techniques to determine and reconstruct a shape and a material property of an object, according to an example. It should be appreciated that the system 1000 depicted in FIG. 10 may be provided as an example. Thus, the system 1000 may or may not include additional features and some of the features described herein may be removed and/or modified without departing from the scopes of the system 1000 outlined herein.

While the servers, systems, subsystems, and/or other computing devices shown in FIG. 10 may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 1000.

As shown in FIG. 10, the system 1000 may include processor 1001 and the memory 1002. In some examples, the processor 1001 may execute the machine-readable instructions stored in the memory 1002. It should be appreciated that the processor 1001 may be a semiconductor-based microprocessor, a central processing unit (CPU), an application specific integrated circuit (ASIC), a field-programmable gate array (FPGA), and/or other suitable hardware device.

In some examples, the memory 1002 may have stored thereon machine-readable instructions (which may also be termed computer-readable instructions) that the processor 1001 may execute. The memory 1002 may be an electronic, magnetic, optical, or other physical storage device that contains or stores executable instructions. The memory 1002 may be, for example, random access memory (RAM), an Electrically Erasable Programmable Read-Only Memory (EEPROM), a storage device, an optical disc, or the like. The memory 1002, which may also be referred to as a computer-readable storage medium, may be a non-transitory machine-readable storage medium, where the term “non-transitory” does not encompass transitory propagating signals. It should be appreciated that the memory 1002 depicted in FIG. 10 may be provided as an example. Thus, the memory 1002 may or may not include additional features, and some of the features described herein may be removed and/or modified without departing from the scope of the memory 1002 outlined herein.

It should be appreciated that, and as described further below, the processing performed via the instructions on the memory 1002 may or may not be performed, in part or in total, with the aid of other information and data. Moreover, and as described further below, it should be appreciated that the processing performed via the instructions on the memory 1002 may or may not be performed, in part or in total, with the aid of or in addition to processing provided by other devices.

In some examples, and as discussed further below, the instructions 1003-1009 on the memory 1002 may be executed alone or in combination by the processor 1001 for implementing structured polarized illumination techniques to determine and reconstruct a shape and a material property of an object.

In some examples, the instructions 1003 may implement an illumination source (e.g., a laser diode) to emit light towards an arrangement of at least one grating (e.g., one or more Pancharatman-Berry (PB) gratings).

In some examples, the instructions 1004 may determine an input Stokes vector. In some examples, the instructions 1004 may determine the input Stokes vector based on the light emitted towards the arrangement of the at least one Pancharatman-Berry (PB) grating.

In some examples, the instructions 1005 may implement a polarization camera to capture light reflected from an object whose shape and material properties are to be determined. In some examples, the polarization camera may include a plurality of super-pixels having a plurality of pixels. In some examples each of the plurality of pixels may be associated with a wire grid having a particular wire grid orientation.

In some examples, the instructions 1006 may implement a plurality of illumination cards for imaging light captured (e.g., by a polarization camera) upon reflection from an object. In some examples, the instructions 1006 may implement a projection of fringes and an associated fringes analysis utilizing the plurality of illumination cards. In some examples, the plurality of illumination cards may include a black illumination card having a smaller angle of incidence (AOI), a black illumination card having a larger angle of incidence (AOI), a white illumination card having a smaller angle of incidence (AOI), and white illumination card having a larger angle of incidence (AOI).

In some examples, the instructions 1007 may determine a shape of an object. In particular, in some examples, the instructions 1007 may utilize a projection of fringes and an associated fringes analysis (e.g., as implemented via the instructions 1006) to determine the shape of the object using structured polarized illumination. In some examples, the instructions 1007 may determine a map of surface normals that may be associated with a shape of the object.

In some examples, the instructions 1008 may determine an output Stokes vector. In particular, in some examples, the instructions 1008 may determine the output Stokes vector based on a projection of fringes and an associated fringes analysis (e.g., as implemented via the instructions 1006).

In some examples, the instructions 1009 may determine a Mueller matrix for an object that may describe material properties of the object. In some examples, the instructions 1009 may utilize an input Stokes vector (e.g., as determined via the instructions 1004) and an output Stokes vector (e.g., as determined via the instructions 1008) to determine the Mueller matrix for the object.

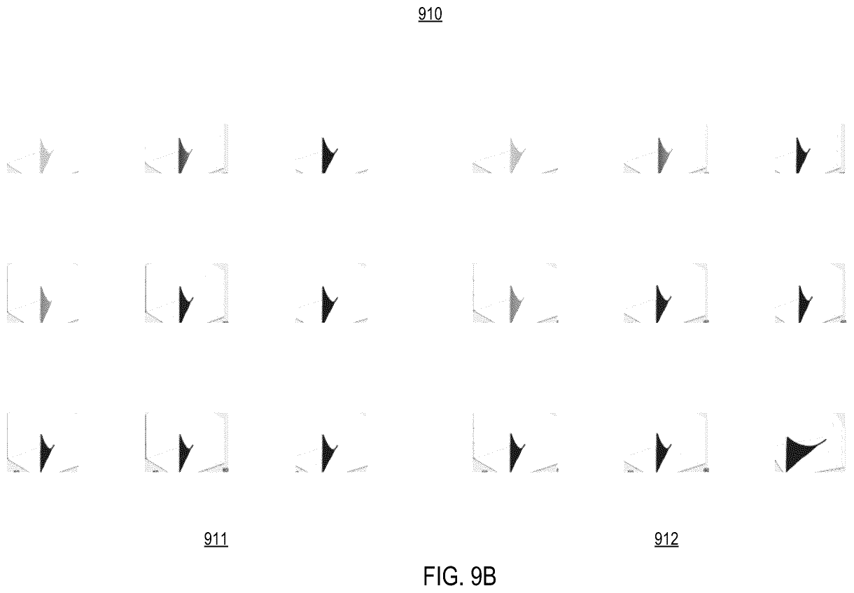

FIG. 11 illustrates a method 1100 for implementing structured polarized illumination techniques to determine and reconstruct a shape and a material property of an object, according to an example. The method 1100 is provided by way of example, as there may be a variety of ways to carry out the method described herein. Each block shown in FIG. 11 may further represent one or more processes, methods, or subroutines, and one or more of the blocks may include machine-readable instructions stored on a non-transitory computer-readable medium and executed by a processor or other type of processing circuit to perform one or more operations described herein. Although the method 1100 is primarily described as being performed by system 1000 as shown in FIG. 10, the method 1100 may be executed or otherwise performed by other systems, or a combination of systems.

Reference is now made with respect to FIG. 11. At 1110, a plurality of Pancharatman-Berry (PB) gratings may be arranged. In some examples, this may include arranging a first Pancharatman-Berry (PB) grating may be used to take a light beam and create two, deviating virtual point sources of light. In some examples, a second Pancharatman-Berry (PB) grating may receive the two virtual point sources of light, and may emit them (e.g., recombine them) as overlapping light beams.

At 1120, a light beam may be emitted toward a plurality of gratings (e.g., the plurality of Pancharatman-Berry (PB) gratings arranged at 1110), and further toward an object whose shape and material properties may be determined.

At 1130, an input Stokes vector may be determined for a light beam emitted toward an object whose shape and material properties may be determined. In some examples, the input Stokes vector may be determined based on the intensity of the light beam.

At 1140, a polarization camera may receive light reflected from an object whose shape and material properties may be determined. In some examples, the polarization camera may include at least one (e.g., a plurality) of pixels that may have a varied wire grid orientation. In some examples, a first pixel may have a wire grid orientation α=0 degrees, a second pixel may have a wire grid orientation α=45 (or π/4) degrees, a third pixel 603c may have a wire grid orientation α=90 (or π/2) degrees, and a fourth pixel 603d may have a wire grid orientation α=135 (or −π/4) degrees.

At 1150, a plurality of illumination cards may be utilized to image light captured (e.g., by a polarization camera) upon reflection from an object whose shape and material properties may be determined. In some examples, the plurality of illumination cards may be utilized to generate a plurality of images that may each associated with a particular pixel and an associated wire grid of the polarization camera.

At 1160, a shape of an object may be determined. In particular, in some examples, the shape of the object may be determined based on structured polarized illumination (e.g., as provided via instructions 1110-1150) and analysis of fringes produced based on a varying polarization states, which may produce a (corresponding) contrast in the fringes. In some examples, these images having shifted patterns with associated distinct fringes may be utilized to reconstruct a shape of an object.

At 1170, an output Stokes vector may be determined. In particular, in some example, based on (among other things) intensities of light captured by a plurality of pixels on a polarization camera, a known polarization state variation, a shift in fringes, and a contrast in the (shifted) fringes, an output Stokes vector may be determined.

At 1180, a Mueller matrix associated with material properties of an object may be determined. In some examples, the determination of the output Stokes vector mat be based on three parameters including theta_i (or θᵢ), which may represent a zenith incident angle with respect to a normal, theta_o (or θₒ), which may represent a zenith viewing angle, and phi (ϕ), which may represent an azimuth different between incident and scattered rays. In some examples, the three parameters may be associated with a given incident and scattering angle. In some examples, a Mueller matrix may be determined based on an input Stokes vector associated with an object (e.g., as determined at 1130) and an output Stokes vector associated with the object (e.g., as determined at 1170)

In some examples, an anti-reflective (AR) coating may be applied to one or more sides of a glass substrate. In some examples and as used herein, an anti-reflection (AR) coating may be a type of optical coating that may be applied to a surface of a lens or other optical element to reduce reflection. In some examples, the anti-reflective (AR) coating may function in visible range of the electromagnetic spectrum, while in other examples, the anti-reflective (AR) coating may function in the ultraviolet (UV) light range of the electromagnetic spectrum.

So, in some examples, an anti-reflective (AR) coating may improve efficiency of an optical component, as less light may be lost due to reflection. In addition, in some instances, use of an anti-reflection (AR) may improve an image contrast via elimination of stray light.

In some examples, a glass substrate having an anti-reflective (AR) coating may be utilized for waveguide fabrication. In particular, the glass substrate may include an anti-reflective (AR) coating on one side but not an opposite side.

It may be appreciated that mistakenly utilizing a wrong side (e.g., where an anti-reflective (AR) coating may be on an opposite side) may lead to an excess amount of light accumulating on and/or emanating from a sample (e.g., a glass substrate), and may lead to errors on a following sample during fabrication.

Specifically, in some instances, if an anti-reflective (AR) coating may be on a wrong (or opposite) side, then this error may be magnified during a duplication portion of a fabrication process, and may even be carried to other liquid crystal (LC) elements of a display component. In some instances, this may significantly lower image quality and device performance. Accordingly, it may be beneficial to be able to quickly determine which side an anti-reflective (AR) coating may be provided on.

It may also be appreciated that a determination of which side may include an anti-reflective (AR) coating may not be easy and quick. For example, in some cases, a spectrum measurement that may be utilized, but may not necessarily work for a single anti-reflective (AR) coating substrate, since spectrum measurement technique may require multiple measurements utilizing two anti-reflective (AR) coating substrates.

Also, in some examples, a typical method that may be used to determine which side of a glass substrate may include an anti-reflective (AR) coating may include utilizing a spectrometer. In particular, in some examples, this may include attaching two pieces of anti-reflective (AR) coating substrate together (e.g., next to each other) and sandwiching a layer of liquid (e.g., oil, isopropyl alcohol, water, etc.) for index matching. In some examples, this may require four (4) measurements (e.g., front to front, front to back, back to front, and back to back) with an ultraviolet (UV) spectrometer. As a result, in some instances, the process may take excessive time (e.g., fifteen (15) minutes or more), and may lead to a higher risk of damaging an anti-reflective (AR) coating.

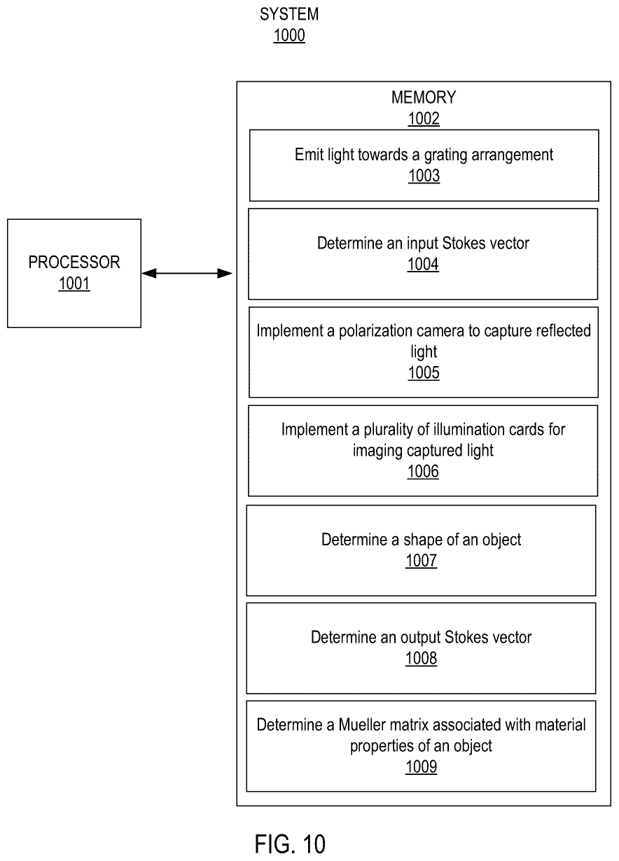

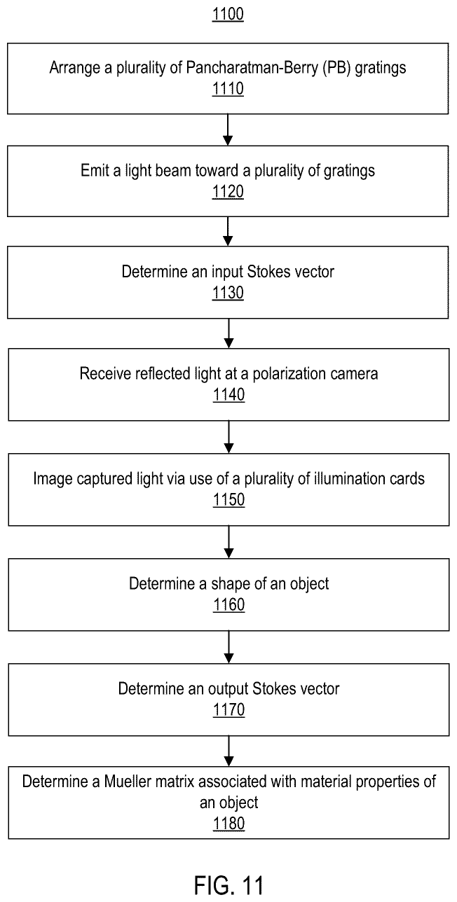

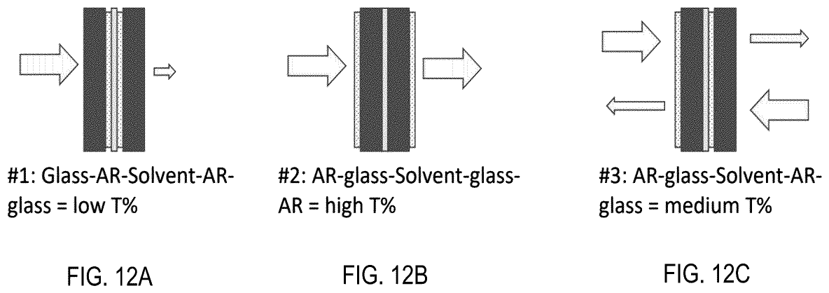

FIG. 12A illustrates a glass substrate wherein anti-reflective (AR) coatings may be facing inward, according to an example. So, in some examples, if the anti-reflective (AR) coated sides may be facing inward, then the anti-reflective (AR) coated sides may not function and the glass substrate arrangement may lose ultraviolet (UV) energy and a transmittance percentage (T %) may be lower.

FIG. 12B illustrates a glass substrate wherein anti-reflective (AR) coatings may be facing outward, according to an example. In some examples, if the anti-reflective (AR) coated sides may be facing outward, then the anti-reflective (AR) coatings will function with respect to both sides, the transmittance percentage (T %) may be higher (e.g., closer to one hundred percent (100%)).

FIG. 12C illustrates a glass substrate wherein anti-reflective (AR) coatings may be facing in different directions, according to an example. That is, in some examples, a first anti-reflective (AR) coated side may face inward and a second anti-reflective (AR) coated side may face outward, one side may function normally while the other side may not and may instead lose energy. Accordingly, in some examples, the transmittance percentage (T %) may be medium. However, implementing the testing procedures provided in FIG. 12A-12C may be a relatively inaccurate and inefficient.

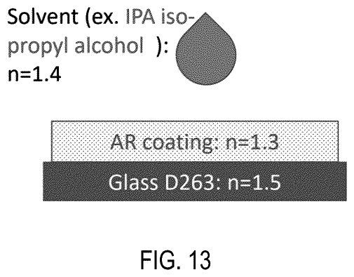

For testing of visible light anti-reflective (AR) coatings, in some instances, another method may be implemented. Such a method is illustrated in FIGS. 13, 14A-14B, and 15A-15B. Specifically, in some examples and as discussed further below, where the anti-reflective (AR) coating may be directed to visible light, a solvent may be utilized to determine which side the anti-reflective (AR) coating may be provided on.

FIG. 13 illustrates providing a solvent on a glass substrate having a visible light anti-reflective (AR) coating, according to an example. In some examples, the solvent may be isopropyl alcohol (IPA), where the isopropyl alcohol (IPA) may have a refractive index of 1.4. In other instances, the solvent may be water (H2O). In some examples, the AR coating may have a refractive index of 1.3 and the glass substrate may have a refractive index of 1.5. In some instances, and as will be discussed below, a difference between the refractive index of the solvent and the refractive indexes of the glass and the anti-reflective (AR) coating may be utilized to determine a difference in how much visible light may be reflected. In some examples, this difference may then be utilized to determine on which side of the glass substrate the visible light anti-reflective (AR) coating may be provided.

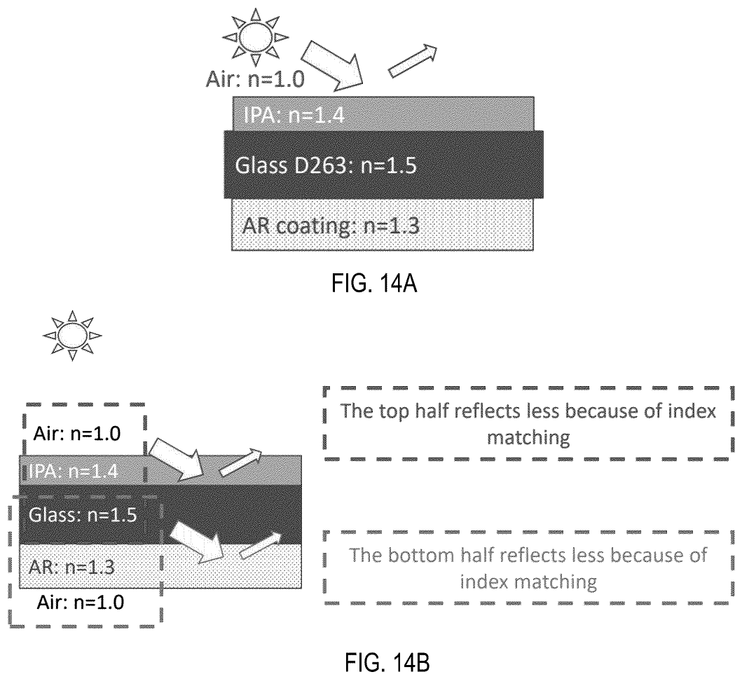

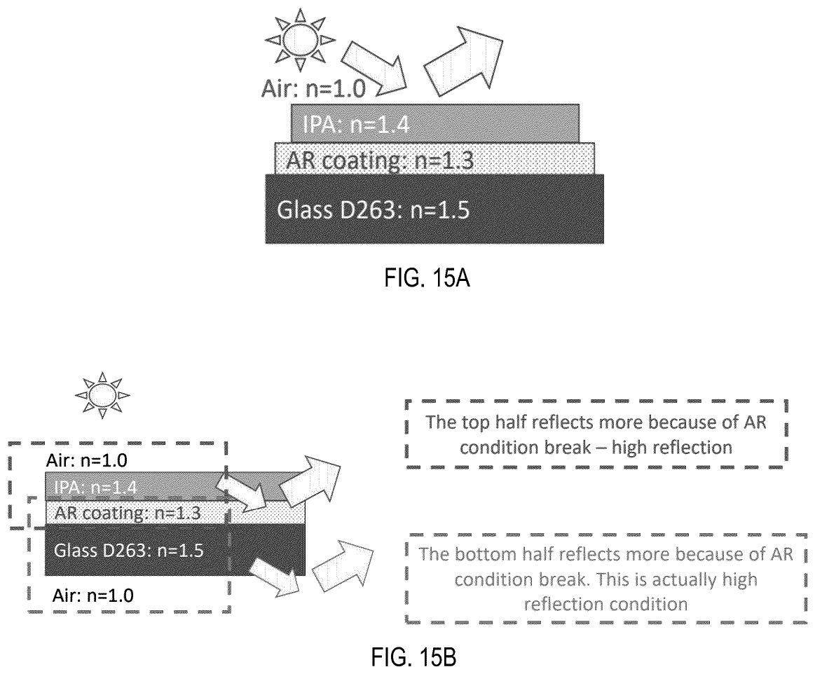

FIG. 14A illustrates providing a solvent on top of a glass substrate where a visible light anti-reflective (AR) coating may further be provided on an opposite side of the glass substrate, according to an example. So, in some examples, a sample of visible light may travel through the air (e.g., having a refractive index of 1.0) and may interface with the solvent (e.g., isopropyl alcohol (IPA)) having a refractive index of 1.4 before reaching the glass substrate. In some examples, the refractive index of the glass substrate may be 1.5 and the refractive index of the visible light anti-reflective (AR) coating may be 1.3.

In some examples, and as discussed above, an amount of visible light that may be reflected may be based upon a difference between index references in between the air and the glass substrate. In particular, in the example illustrated in FIG. 14A, where an anti-reflective (AR) coating side may be on bottom, because the refractive index may transition from “low” (e.g., air having a refractive index of 1.0) to “medium” (e.g., solvent having a refractive index of 1.4) to “high” (e.g., a glass substrate having a refractive index of 1.5), the solvent may act as a de facto anti-reflective (AR) coating, and this may result in less reflection of the visible light and the glass substrate surface may appear less shiny or reflective.

FIG. 14B illustrates aspects of light reflectivity associated with providing a solvent on top of a glass substrate where a visible light anti-reflective (AR) coating may be provided on an opposite side of the glass substrate, according to an example. In some examples, and as indicated by red boxes in FIG. 14B, this arrangement may provide a transition from “low” (e.g., air having a refractive index of 1.0) to “medium” (e.g., solvent having a refractive index of 1.4) to “high” (e.g., a glass substrate having a refractive index of 1.5). In some instances, this may be referred to as “index matching,” and may provide less reflectivity from these layers.

Also, in some examples, and as indicated by green boxes in FIG. 14B, this arrangement may also provide a transition from “low” (e.g., air having a refractive index of 1.0) to “medium” (e.g., anti-reflective (AR) coating having a refractive index of 1.3) to “high” (e.g., a glass substrate having a refractive index of 1.5). As a result, and as indicated by the decreased reflectivity, it may be determined that the visible light anti-reflective (AR) coating may be located on an opposite side (or bottom) of the glass substrate.

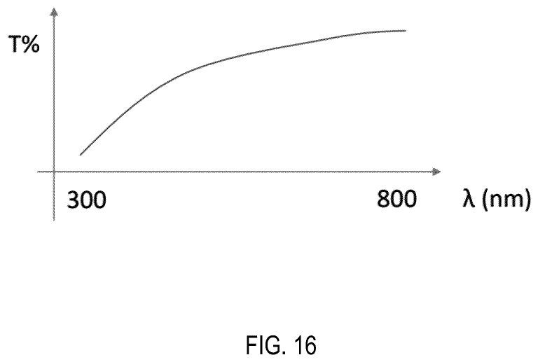

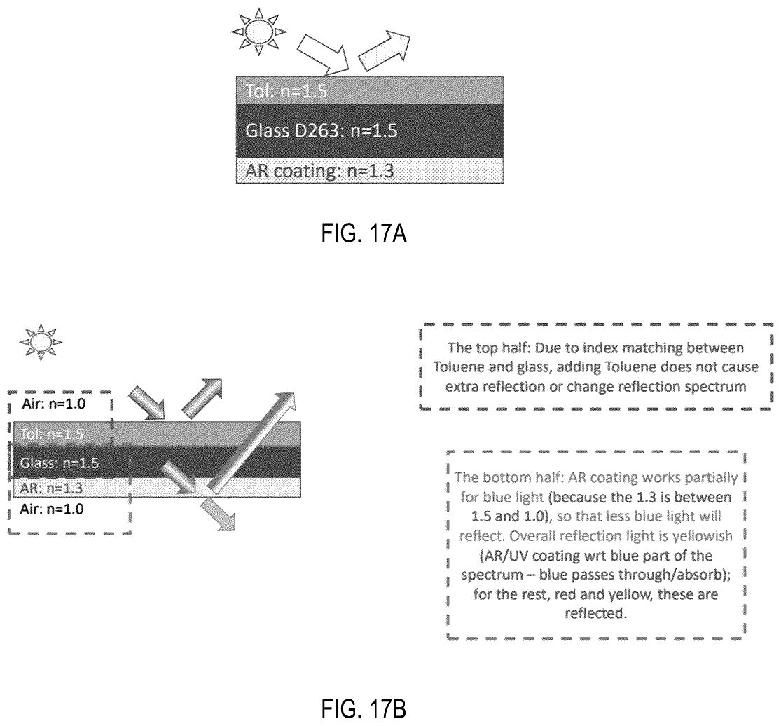

FIG. 15A illustrates providing a solvent on top of a visible light anti-reflective (AR) coating, which may be provided on top of glass substrate, according to an example. So, in this example, where an anti-reflective (AR) coating side may be on top, a sample of visible light may travel through the air (e.g., having a refractive index of 1.0) and may interface with the solvent (e.g., isopropyl alcohol (IPA)) having a refractive index of 1.4 located on top of a visible light antireflective (AR) coating which may further be located on top of a glass substrate. In some examples, the refractive index of the visible light anti-reflective (AR) coating may be 1.3 and the refractive index of the glass substrate may be 1.5.

FIG. 15B illustrates aspects of light reflectivity associated with providing a solvent on top of a visible light anti-reflective (AR) coating, which may be provided on top of glass substrate, according to an example. In some examples, and as indicated by red boxes in FIG. 15B, this arrangement may provide a transition from “low” (e.g., air having a refractive index of 1.0) to “high” (e.g., a glass substrate having a refractive index of 1.5) to “medium” (e.g., visible light anti-reflective (AR) coating having a refractive index of 1.3). In some instances, effects of the visible light anti-reflective (AR) coating may be negative, and this may provide greater reflectivity from these layers.

Also, in some examples, and as indicated by green boxes, this arrangement may also provide a transition from “low” (e.g., air having a refractive index of 1.0) to “high” (e.g., a glass substrate having a refractive index of 1.5) to “medium” (e.g., anti-reflective (AR) coating having a refractive index of 1.3). As a result, in some examples, this may result in greater reflection, and it may be determined that the visible light anti-reflective (AR) coating may be located on a front-facing side (or top) of the glass substrate.

Accordingly, it may be appreciated that, in some examples, if the solvent may be applied on a side that may not have a visible light anti-reflective (AR) coating, a surface may appear dimmer. However, in some examples, if the solvent may be applied on a side that may have a visible light anti-reflective (AR) coating, a surface may appear brighter.

It may be appreciated that, in some instances, a similar process may be utilized to determine a change in reflectiveness for ultraviolet (UV) coating as well. Specifically, depending on a transitioning of refractive index between multiple layers, a reflectiveness associated with a transition may be utilized to determine a sequence of layers.

However, an issue may arise as reflectiveness (e.g., a change in brightness) associated with a large portion of the ultraviolet (UV) spectrum may generally not be visible to the human eye. Indeed, in some instance, an ultraviolet (UV) anti-reflective (AR) coating may not function as anti-reflective (AR) with respect to a visible light wavelength range.

Systems and methods described herein may utilize a change in reflected color associated with a short-wavelength range of visible light to determine a side (or surface) of a sample having an ultraviolet (UV) anti-reflective (AR) coating. In some examples, the systems and methods may determine the side having an ultraviolet (UV) anti-reflective (AR) coating using a single sample.

As will be discussed in further detail below, in some examples, when an ultraviolet (UV) anti-reflective (AR) coating may be in effect (that is, the solvent may be applied on a glass), it may appear to display a yellowish/reddish hue. In some instances, this may be because the yellow and red portions of the visible light spectrum may be (mostly) reflected, but blue portion of the visible light spectrum may mostly not be reflected. As a result, in these instances, an existing color profile may remain, and there may be no color change when compared to before application of the solvent.

However, when the ultraviolet (UV) anti-reflective (AR) coating may not be in effect (e.g., the solvent may be applied on ultraviolet (UV) anti-reflective (AR) coating), the blue portion may be reflected along with the remaining portion of the spectrum, so a color profile in this instances may appear to be a “cold” blue.

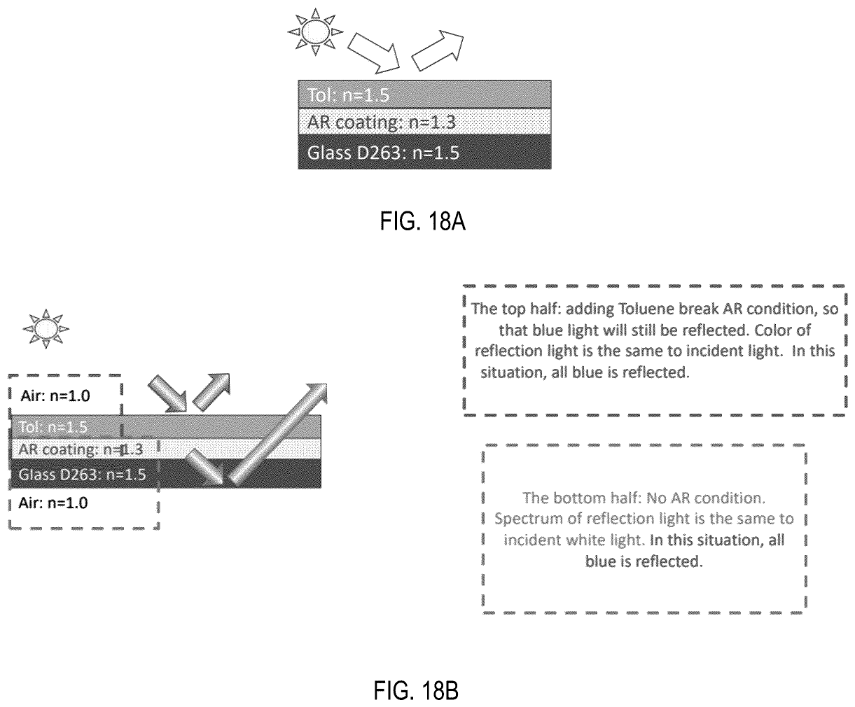

It may be appreciated that a wavelength range associated with a visible light portion of electromagnetic spectrum may be from four hundred (400) to seven hundred (700) nanometers (nm). FIG. 16 illustrates a chart of reflectiveness characteristics of a range of electromagnetic radiation including visible light and ultraviolet (UV) light ranges, according to an example. In some examples, a shortest portion of the visible light portion (e.g., approximately four hundred (400) nanometers (nm)) may “transition” from the visible light portion of the spectrum to the longest portion of ultraviolet (UV) portion of the spectrum. As a result, it may be appreciated that, in some examples, even though an ultraviolet (UV) anti-reflective (AR) coating may be directed to ultraviolet (UV) radiation, it may nevertheless have an anti-reflective (AR) effect for the deep blue and blue portion of the visible light spectrum.

In some examples and as will be discussed further below, the systems and methods described herein may utilize this transition as a basis for a “visible marker” to determine a side (or surface) of a sample having an ultraviolet (UV) anti-reflective (AR) coating. That is, in some examples, the systems and methods may, instead of determining a change (e.g., increase or decrease) in reflectiveness of visible light (as discussed above), instead utilize a change in color of the reflected light to determine the side (or surface) of a sample having an ultraviolet (UV) anti-reflective (AR) coating.

In some examples, the systems and methods may utilize a change in (reflected) color to enable a visual determine of a side (or surface) of a single sample having an ultraviolet (UV) anti-reflective (AR) coating. That is, just based on a change (or no change) in color discernable by the human eye, it may be determined which side of a single sample that an ultraviolet (UV) anti-reflective (AR) coating may be located. In particular, in some examples, since a blue portion of the spectrum may be absorbed (e.g., anti-reflected) and passed through the sample, a sample may appear to have a reddish or yellowish hue (e.g., under visible light in typical room conditions). As a result, when an ultraviolet (UV) anti-reflective (AR) coating may be in effect (or working), it may appear to include a reddish and/or yellowish hue, and may lack a blue coloring or hue. Conversely, where the ultraviolet (UV) anti-reflective (AR) coating may not be in effect (or working), blue light may be reflected and the sample may appear to include an appearance of blue.

In some examples, the systems and methods may include a method for determining a presence of an ultraviolet (UV) anti-reflective (AR) coating on a substrate, comprising applying a solvent on a surface of a substrate, the substrate having an ultraviolet (UV) anti-reflective (AR) coating on a first surface and no coating on an opposite surface; and determining if there is a change in color for the surface of the substrate based on the application of the solvent, and determining if the solvent is applied on the first surface or on the opposite surface based on the change in color for the surface of the substrate. In some examples, the change in color for the surface of the glass substrate may include a reddish or yellowish hue. Also, in some examples, the solvent has a refractive index similar to a refractive index of the substrate, the substrate is a glass substrate and the solvent is toluene, and the solvent has a refractive index of approximately 1.5.

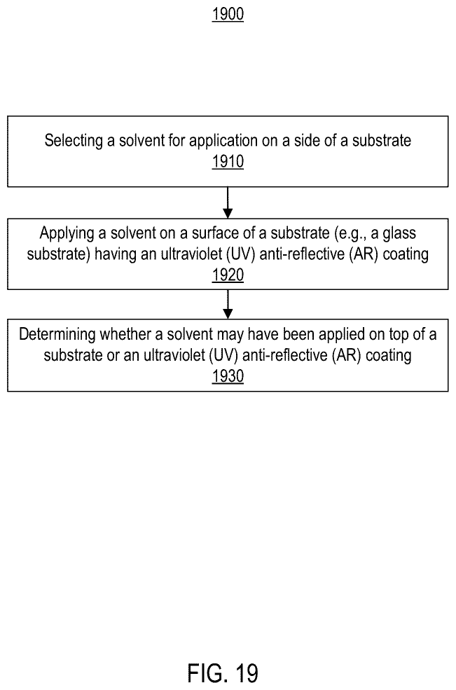

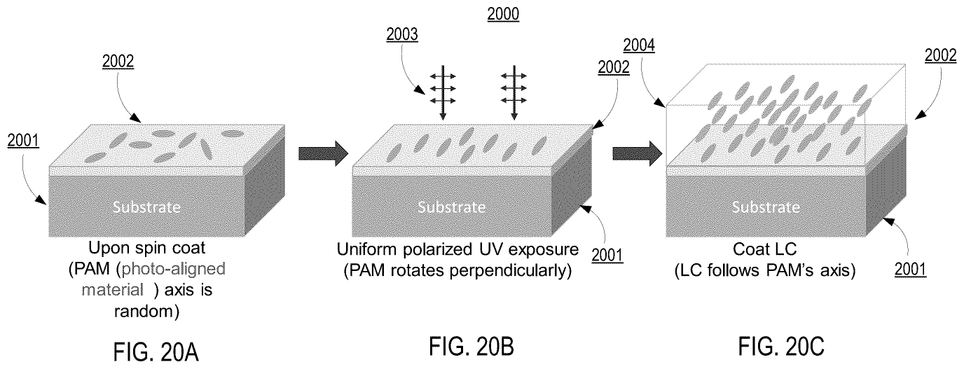

FIG. 17A illustrates a glass substrate with a solvent provided on one side and an ultraviolet (UV) anti-reflective (AR) coating on an opposite side, according to an example. In some examples, the solvent may have a similar refractive index to that of glass (e.g., 1.5). Also, in some examples, the solvent may have a low boiling temperature. For example, in some instances, the solvent may be toluene, wherein the toluene may be applied to a surface of the glass substrate (as shown). In some examples, since the refractive index of the solvent may be similar to the refractive index of the glass, the visible light may reflect off of the solvent in a manner similar to that of the glass.

FIG. 17B illustrates a glass substrate with a solvent provided on glass side and an ultraviolet (UV) coating on an opposite side, according to an example. In some examples, and as indicated by red box, this arrangement may provide a transition from “low” (e.g., air having a refractive index of 1.0) to “high” (e.g., toluene having a refractive index of 1.5) to “same” (e.g., glass substrate having a refractive index of 1.5). In some examples, it may appear that a color change may be minimal or none, and moreover, a total intensity of reflectiveness (e.g., with respect to an index matching condition) for both portions may remain same as well.

In some examples, and as indicated by green box, this arrangement may provide a transition from “high” (e.g., glass substrate having a refractive index of 1.5) to “medium” (e.g., ultraviolet (UV) anti-reflective (AR) coating having a refractive index of 1.3-1.4) to “low” (e.g., air having a refractive index of 1.0). In some examples, because the refractive index of the ultraviolet (UV) anti-reflective (AR) coating falls between that of the solvent and the glass substrate, the ultraviolet (UV) anti-reflective (AR) coating may be effective for a certain (e.g., shortest wavelength) blue portion of the spectrum. As a result, in some examples, the less blue light is likely to reflect (e.g., more blue light is likely to be absorbed by the ultraviolet (UV) anti-reflective (AR) coating), and the overall reflected (e.g., visible) light will remain the same or similar appearance of reddish and/or yellowish under typical ambient room lighting conditions.

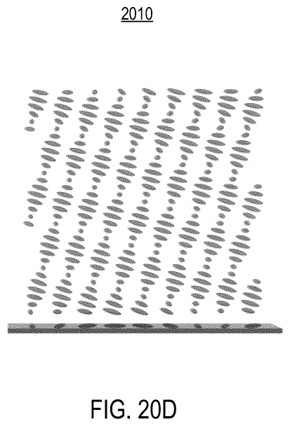

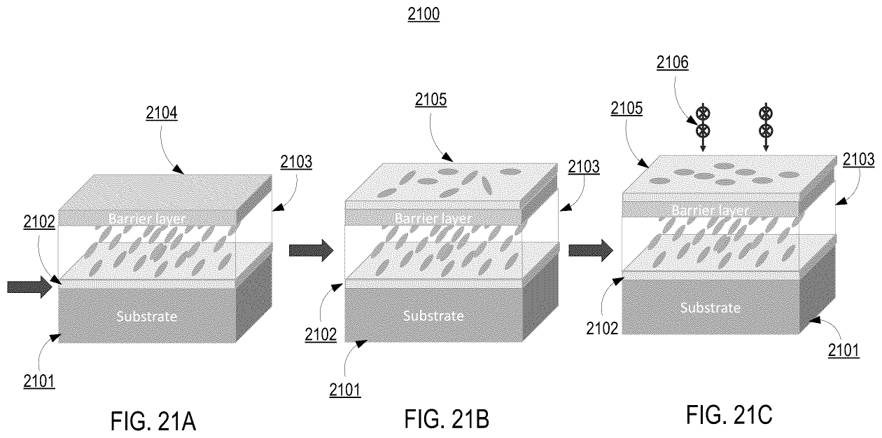

FIG. 18A illustrates a glass substrate with an ultraviolet (UV) anti-reflective (AR) coating on top having a solvent provided on one side, according to an example. In some examples, a solvent may be applied on a side having ultraviolet (UV) anti-reflective (AR) coating. Similar to the example illustrated in FIG. 18A-18B, in some examples, the solvent may have a refractive index to that of glass (e.g., 1.5), along with a low boiling temperature. In some examples, the solvent may be toluene, wherein the toluene may be applied to a surface of the glass substrate. So, in some examples, since the solvent may provide a “high” to “low” to “high” transition (as described above), this will negate the anti-reflective (AR) characteristic of the ultraviolet (UV) anti-reflective (AR) coating for the blue spectrum, and more blue light may be reflected.

FIG. 18B illustrates a glass substrate with an ultraviolet (UV) anti-reflective (AR) coating on top having a solvent (e.g., toluene) provided on one side, according to an example. In some examples, and as indicated by red box, this arrangement may provide a transition from “low” (e.g., air having a refractive index of 1.0) to “high” (e.g., toluene having a refractive index of 1.5) to “medium” (e.g., ultraviolet (UV) anti-reflective (AR) coating having a refractive index of 1.3-1.4). In some examples, an addition of the solvent (e.g., toluene) may negate the anti-reflectiveness (AR) characteristics of the ultraviolet (UV) anti-reflective (AR) coating. As a result, in some examples, blue light may still be reflected.

Also, in some examples, and as indicated by green box, this arrangement may provide a transition from “medium” (e.g., ultraviolet (UV) anti-reflective (AR) coating having a refractive index of 1.3-1.4) to “high” (e.g., glass substrate having a refractive index of 1.5) to “low” (e.g., air having a refractive index of 1.0). As a result, in some examples, anti-reflective (AR) characteristics of the ultraviolet (UV) anti-reflective (AR) coating may be negated, so it may appear more to have an additionally blue hue compared to before application of the toluene.

Accordingly, in some examples, when an ultraviolet (UV) anti-reflective (AR) coating is may be in effect (that is, the solvent may be applied on a glass), it may appear to display a yellowish/reddish hue since yellow and red portion of the visible light spectrum may be mostly reflected but blue portion of the visible light spectrum may mostly not. In these instances, a color profile may remain and there may be no color change when compared to before application of the solvent. However, when the ultraviolet (UV) anti-reflective (AR) coating is may not be in effect (the solvent may be applied on ultraviolet (UV) anti-reflective (AR) coating), the blue portion may be reflected along with the remaining portion of the spectrum, so a color profile may appear to be a “cold” blue.

The systems and methods described herein may provide various advantages. In some examples, the systems and methods describe may utilize a single sample (e.g., a glass substrate having an anti-reflective (AR) coating), and may only require a visual inspection to provide an association conclusion (e.g., which side the anti-reflective (AR) coating may be on. Moreover, in some instances, the systems and methods may be implemented and/or conducted within a minimal time period (e.g., one (1) minute), and therefore may be substantially more efficient and effective than prevailing alternatives.

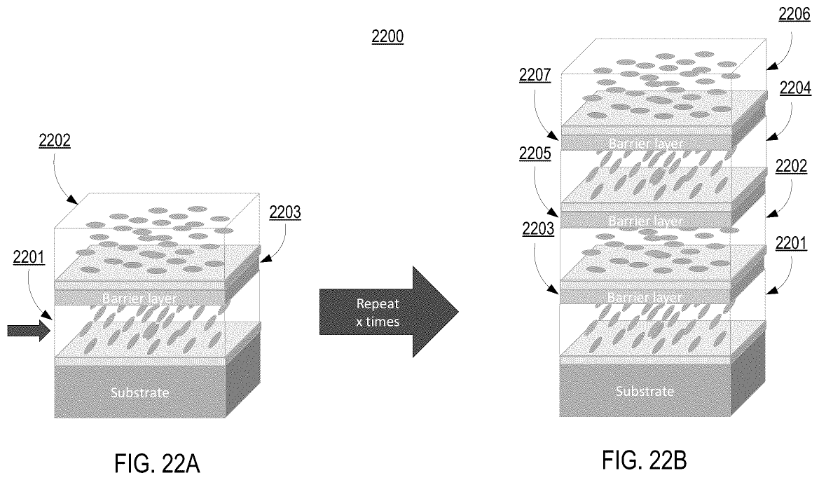

FIG. 19 illustrates a method for determining a presence of an ultraviolet (UV) anti-reflective (AR) coating on a substrate, according to an example. The method 1000 is provided by way of example, as there may be a variety of ways to carry out the method described herein. Each block shown in FIG. 19 may further represent one or more processes, methods, or subroutines, and at least one of the blocks may include machine-readable instructions stored on a non-transitory computer-readable medium and executed by a processor or other type of processing circuit to perform one or more operations described herein. In some examples, the method 1900 may be executed or otherwise performed by other systems, or a combination of systems.

Reference is now made with respect to FIG. 19. At 1910, the method may include selecting a solvent for application on a side of a substrate. In some examples, the substrate may be glass. In some examples, the substrate may include an anti-reflective (AR) coating, where it may not be clear which side of the substrate the anti-reflective (AR) coating may be applied.

In some examples, the solvent may have a refractive index similar to that of the substrate. So, in an instance where the substrate may be glass having a refractive index of index one point five (1.5), a solvent with a similar index may be selected. In some examples, the solvent may be toluene.

At 1920, the method may include applying a solvent on a surface of a substrate (e.g., a glass substrate) having an ultraviolet (UV) anti-reflective (AR) coating. So, in an example where the solvent may be toluene, the toluene may be applied to one surface of the glass substrate.

At 1930, the method may include determining whether a solvent may have been applied on top of a substrate or an ultraviolet (UV) anti-reflective (AR) coating. In particular, in some examples, the method may include determine a color change (e.g., a change in reflectiveness characteristics) of a surface on which a solvent may have been applied.

So, in an example where the solvent may have been applied on a surface of a substrate (e.g., a glass substrate), also referred to as “the non-anti-reflective side), a top portion of may exhibit no change in reflectiveness characteristics. However, in some examples, for a bottom portion (e.g., wherein the ultraviolet (UV) anti-reflective (AR) coating may be provided), the ultraviolet (UV) anti-reflective (AR) coating may function to reflect less blue light (e.g., the blue light may be absorbed). As a result, in some examples, a reflection of visible light from a surface may appear reddish and/or yellowish.

Also, in an example where the solvent may have been applied on a surface where an ultraviolet (UV) anti-reflective (AR) coating may be provided, a top portion of may exhibit no change in reflectiveness characteristics (e.g., blue light may still be reflected), and reflected light may appear same as incident light. Also, in some examples, for a bottom portion (e.g., wherein the glass substrate may be provided), there may be no change in reflectiveness characteristics (e.g., blue light may still be reflected), and reflected light may appear same as incident light.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

In some examples, conventional methods of fabricating polarization gratings (e.g., liquid crystal (LC) gratings) may be limited to providing one grating per side of a substrate. As used herein, in some instances, the term “polarization grating” may be used interchangeably with “volume hologram” or “polarization volume hologram.” In particular, in some examples, a polarization grating may include a single grating per side having a single surface pattern.

In some examples, conventional methods of fabricating polarization gratings (e.g., liquid crystal (LC) gratings) may be limited to providing one grating per side of a substrate. As used herein, in some instances, the term “polarization grating” may be used interchangeably with “volume hologram” or “polarization volume hologram.” In particular, in some examples, a polarization grating may include a single grating per side having a single surface pattern.

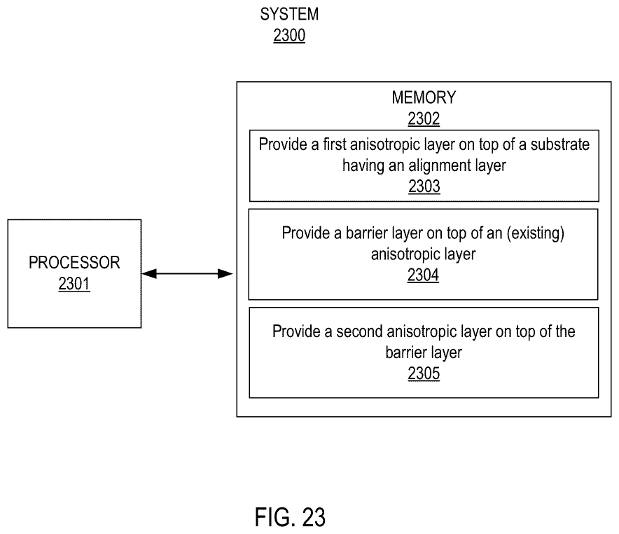

FIGS. 20A-20D illustrate various aspects of a polarization grating having a single surface pattern, according to an example. As illustrated in FIG. 20A, in some examples, an alignment layer 2002 may be provided on top of a substrate 2001. In some examples, the alignment layer 2002 may have a polarization axis that may be random. In some examples, the alignment layer 2002 may also be referred to as a “photo-aligned material (PAM).”

In some examples, as illustrated in FIG. 20B, the alignment layer 2002 may be patterned via directed polarized (e.g., ultraviolet (UV)) light 2003. While in some examples, polarized (e.g., ultraviolet (UV)) light may be utilized to pattern an alignment layer, it may be appreciated that in other examples, other examples of light (e.g., blue light) may be utilized as well. In some examples, the alignment layer 2002 may absorb the polarized light 2003 and the polarization axis of the alignment layer 2002 may be aligned to an orientation (or “pitch”) accordingly.

In some examples, the alignment layer 2002 may be aligned in a manner that may be perpendicular to an orientation of the polarized light 2003. It may be appreciated that, in some examples, the alignment layer 2002 may be patterned using any number of polarization lithography techniques.

In some examples, as illustrated in FIG. 20C, an anisotropic material 2004 (e.g., liquid crystal (LC)) may be provided on top of the alignment layer 2002. In some examples, the anisotropic material 2004 may have a particular orientation (or pitch). In some examples, the anisotropic material 2004 may exhibit an orientation (or pitch) that may be acquired from the alignment layer 2002. FIG. 20D illustrates an example 2010 of a polarization orientation that may be provided (e.g., via the polarized light 2003), according to an example.

It may be appreciated that, in some instances, a grating structure may be comprised of a plurality of anisotropic layers (e.g., liquid crystal (LC) layers). In some examples, a grating structure may be utilized for, for example, providing a larger field-of-view (FOV) and enhanced color uniformity. However, typically, a subsequent (e.g., top) anisotropic layer that may be coupled to a previous (e.g., bottom) anisotropic layer may acquire a same alignment (e.g., pitch or orientation) as the previous layer.

In some instances, such limiting of pitch or orientation of one or more anisotropic layers may limit degrees of freedom and functionality of a grating structure. For example, in some instances, this may require coating a plurality of grating layers onto a plurality of (corresponding) substrates (e.g., one grating on each side of a substrate), and then gluing substrates together to create a grating structure. It may be appreciated that this may lead to additional bulk for an optical component, and may create alignment issues among the plurality substrates of the grating structure.

Systems and methods described herein may be directed to stacking multiple deposited anisotropic layers of a polarization grating structure using a barrier layer. In some examples, and as will be discussed further below, the systems and methods may provide a grating structure comprised of multiple grating layers stacked on top of each other that may exhibit independent pitch or orientation for each of a plurality of anisotropic (e.g., liquid crystal (LC)) layers.

In some examples, the systems and methods may implement an intermediary (or “barrier”) layer that may be provided on top of a first (e.g., bottom) polarization grating that may enable subsequent processing of a second (e.g., top) polarization grating in a manner that may be unaffected by the first polarization grating.

In particular, in some examples, the systems and methods may provide a plurality of anisotropic (e.g., liquid crystal (LC)) layers that may each exhibit independent pitch or orientation. As a result, in some examples, by providing a barrier layer on top of a first polarization grating, this may enable independent processing of a following layer such that the following layer may exhibit alignment properties (e.g., pitch or orientation) independent of a previous layer.

In some examples, a barrier layer as provided herein may be comprised of an isotropic material. In particular, in some examples, the barrier layer may be comprised of the isotropic material to enable a decoupling (or canceling) of alignment properties present a previous (e.g., anisotropic) grating layer.

In some examples, by providing the (e.g., isotropic) barrier layer on top of an anisotropic (e.g., liquid crystal) layer of a grating layer, the barrier layer may enable a new polarization arrangement with no preexisting (or associated) alignment(s). In particular, in some examples, this may enable a second grating structure to be provided on top of a first grating structure, wherein a second alignment layer (or photo-aligned material (PAM)) to be provided on top of a second substrate, the second alignment layer may be exposed to polarized (e.g., ultraviolet (UV)) light to create an orientation or pitch that may be different than that exhibited by the first grating structure, and may enable implementation of an anisotropic (e.g., liquid crystal (LC)) layer that may mirror the (different) orientation of the second alignment layer.

In some examples, a method for depositing isotropic layers using a barrier layer, comprising: depositing a first alignment layer on top of a substrate, exposing the first alignment layer to an ultraviolet (UV) light source to provide first polarization orientation to the first alignment layer, providing a first anisotropic layer on top of the first alignment layer, wherein the first anisotropic layer is to acquire the first polarization orientation of the first alignment layer, providing an isotropic barrier layer on top of the first anisotropic layer, depositing a second alignment layer on top of the isotropic barrier layer, exposing the second alignment layer to the ultraviolet (UV) light source to provide second polarization orientation to the second alignment layer, and providing a second anisotropic layer on top of the second alignment layer, wherein the second anisotropic layer is to acquire the second polarization orientation of the second alignment layer. In some examples, the second polarization orientation is different than the first polarization orientation and the first anisotropic layer and the second anisotropic layer are comprised of liquid crystal (LC). In some examples, the isotropic barrier layer is comprised of silicon dioxide (SiO₂) and the isotropic barrier layer is to absorb specified optical wavelength ranges.

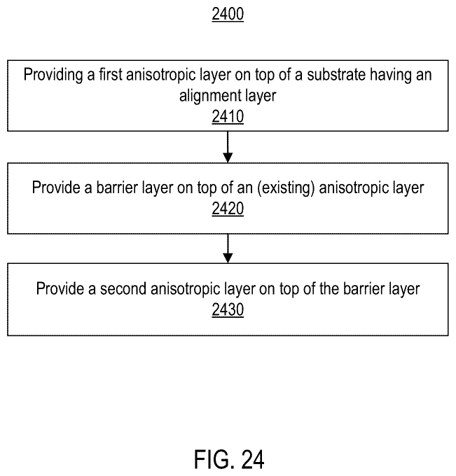

FIGS. 21A-21C illustrate aspects of fabrication of a plurality of grating layers utilizing a barrier layer, according to an example. In some examples, as illustrated in FIG. 21A, an alignment layer 2102 located on top of a substrate 2101 may be utilized to provide alignment properties (e.g., pitch or orientation) to an anisotropic layer (e.g., liquid crystal (LC) layer) 2103, as discussed above.

In some examples, upon imparting of alignment properties from the alignment layer 2102 to the anisotropic layer 2103, a barrier layer 2104, having isotropic characteristics, may be provided (e.g., coated) on top of the anisotropic layer 2103. As will be discussed further below, the barrier layer 2104 may, in some examples, enable implementation of an additional anisotropic (e.g., liquid crystal (LC)) layer that may exhibit a different polarization orientation than the anisotropic layer 2103.

In some examples, the barrier layer 2104 may be added to the top of the anisotropic layer 2103 via a deposition process. Examples of such deposition process may include, but are not limited to, sputtering, evaporation, and spinning. As discussed above, in some examples, upon depositing the barrier layer 2104 on top of the anisotropic layer 2103, the alignment properties of the anisotropic layer 2103 may be decoupled with respect to any subsequent layers (e.g., added on top). As a result, as illustrated in FIG. 21B, a second alignment layer may be provided on top of the barrier layer 2104 which may provide a (different) polarization orientation to a following (or subsequent) anisotropic layer that may be provided on top. That is, in some examples, the barrier layer 2104 may serve as a de-facto “substrate” layer on top of which a (following) anisotropic layer having independent alignment properties may be provided.

In FIG. 21C, a polarized (e.g., ultraviolet (UV)) light source 2106 may be utilized to provide (independent and/or unique) alignment properties (e.g., pitch or orientation, pattern) to the second alignment layer 2105. In some examples, a second anisotropic layer (not shown) may be provided on top of the second alignment layer 2105, thereby facilitating a plurality of grating layers stacked on top of each other and on one side of a substrate that may exhibit independent pitch or orientation.

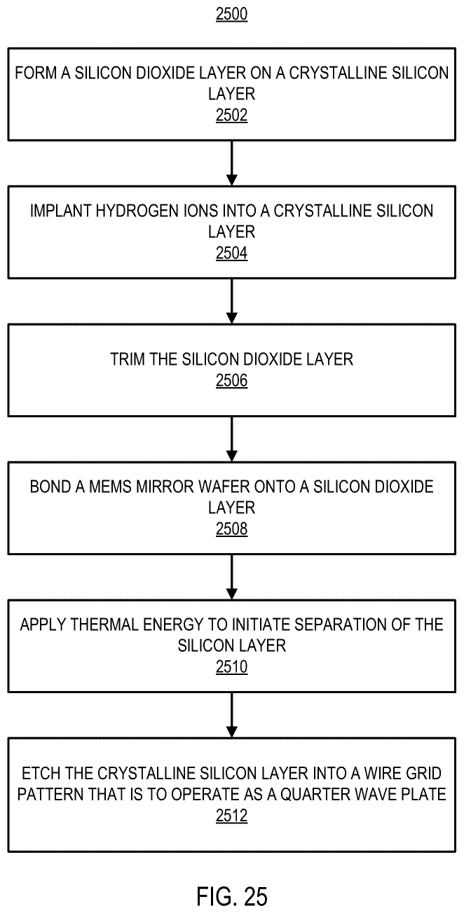

FIGS. 22A-22B illustrate aspects of a plurality of grating layers stacked on top of each other exhibiting independent pitch or orientation, according to an example. In some examples, similar to the examples illustrated in FIG. 21A-21C, a barrier (e.g., isotropic) layer 2203 may be provided on top of a first anisotropic (e.g., liquid crystal (LC)) layer 2201.

As a result, a second anisotropic (e.g., liquid crystal (LC)) layer 2202, having alignment properties independent of the first anisotropic layer may be implemented. In some examples, the barrier layer 2203 may serve to de-couple properties of the first anisotropic layer 2201 from the second anisotropic layer 2202. Indeed, it may be appreciated that, in this manner and in some examples, any number of anisotropic layers (e.g., three, four, etc.) having independent properties may be implemented on top of each other.

FIG. 22B illustrates the second anisotropic (e.g., liquid crystal (LC)) layer 2203 that may be located on top of the first anisotropic (e.g., liquid crystal (LC)) layer 2201 via the barrier layer 2203. In addition, a third anisotropic (e.g., liquid crystal (LC)) layer 2204 may be located on top of the second anisotropic (e.g., liquid crystal (LC)) layer 2204 via the barrier layer 2205, and a fourth anisotropic (e.g., liquid crystal (LC)) layer 2206 may be located on top of the third anisotropic (e.g., liquid crystal (LC)) layer 2204 via the barrier layer 2207.

It may be appreciated that, in some examples, a barrier layer as described herein may have a sufficient and/or minimum thickness that may be necessary to de-couple alignment properties of a first anisotropic layer from a second-anisotropic layer. In some examples, a sufficient and/or minimum thickness of the barrier layer may be based on the material comprising the barrier layer.

In some examples, a barrier layer as described may be comprised of various materials. It may be appreciated that, in some examples, a barrier layer may be made of any material may exhibit isotropic characteristics. In some examples, the barrier may be made of a transparent material as well. For example, in some instances, the barrier layer may be comprised of an inorganic material, such as silicon dioxide (SiO₂), silicon nitride (Si_{X}N_{Y}), or magnesium fluoride (MgF), that may be deposited, for example, via a sputtering process. In another example, the barrier layer may be comprised of an organic material, such as (e.g., spin-coated) SU-8 polymer layer, a photoresist layer, or a layer of curable glue. It may be appreciated that, in general, the barrier layer may be comprised of any material that may have optical properties that may be desired for the application.

In some examples, the barrier layer may be capable of absorbing certain optical wavelength ranges to enable the barrier layer to function as a color filter. Also, in some examples, the barrier layer may be capable of reflecting certain optical wavelength ranges as well.

It may be appreciated that the systems and methods described herein may provide various benefits, advantages, and applications. Indeed, in some instances, the systems and methods may be applied in any setting or context where multiple polarization gratings or polarization volume holograms may be stacked together. For example, as discussed above, in some examples, the system and methods described may enable a plurality (e.g., three or more) gratings on one substrate. In some examples, the plurality of gratings may enable multiple pupil location mechanisms within a retinal projection system in a display device (e.g., augmented reality (AR) eyeglasses).

In some examples, the systems and method described may be utilized to provide grating structures that may exhibit additional bandwidth, such that the grating structures may be able to implement broader wavelength ranges (e.g., additional colors). In addition, in some examples, a grating structure comprised of multiple grating layers stacked on top of each other exhibiting independent pitch or orientation may broaden a field of view (FOV) for waveguide applications, and may provide a larger eyebox (e.g., area) as well. Indeed, in some examples, the systems and methods described herein may enable fabrication of a two-dimensional (2D) grating, and may, in some instances, enable elimination of an intermediary (or “folding”) grating.

Additionally, in some examples, the systems and methods may enable multiple grating structures to be located on one side of a substrate (e.g., user-side or eyeside), such that coating procedures (e.g., anti-reflective (AR) coating) may be more efficiently and effectively conducted. Moreover, as a result, an opposing side may be made available for other purposes as well. It may be appreciated that barrier layers as described herein may also facilitate double-sided processing, wherein one or more grating structures may be located on an opposing side (e.g., world-side) as well.

In some examples, a barrier layer as described herein may implemented as a dual-purpose entity, wherein a first purpose of the barrier layer may be to enable a following layer to exhibit alignment properties (e.g., pitch or orientation) independent of a previous layer, but a second purpose of the barrier layer may be to function as, for example, an anti-reflective (AR) coating layer. In particular, in some examples, a material or materials of the barrier layer may be selected and/or provided to enable both a first purpose (e.g., providing independent alignment properties) and a second purpose (e.g., anti-reflective (AR) coating).

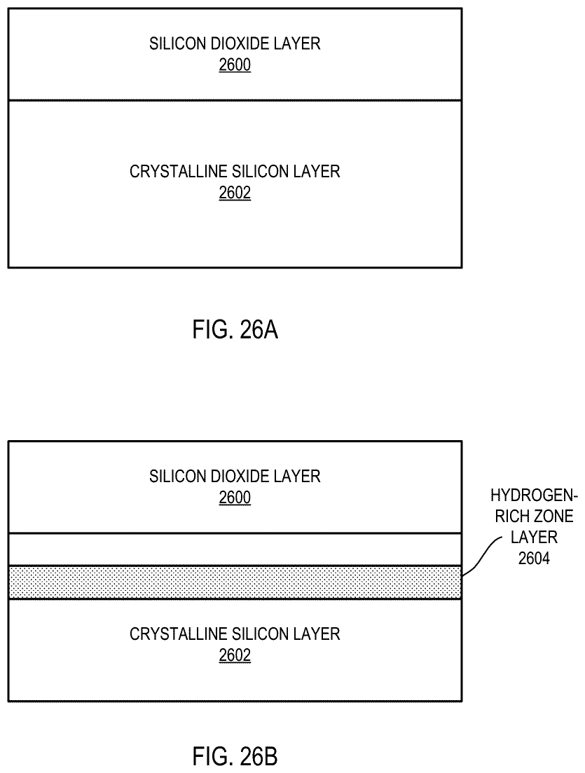

Reference is now made to FIG. 23. FIG. 23 illustrates a block diagram of a system 2300 for stacking multiple deposited anisotropic layers of a polarization grating structure using a barrier layer, according to an example. It should be appreciated that the system 2300 depicted in FIG. 23 may be provided as an example. Thus, the system 2300 may or may not include additional features and some of the features described herein may be removed and/or modified without departing from the scopes of the system 2300 outlined herein.

While the servers, systems, subsystems, and/or other computing devices shown in FIG. 23 may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 2300.

As shown in FIG. 23, the system 2300 may include processor 2301 and the memory 2302. In some examples, the processor 2301 may execute the machine-readable instructions stored in the memory 2302. It should be appreciated that the processor 2301 may be a semiconductor-based microprocessor, a central processing unit (CPU), an application specific integrated circuit (ASIC), a field-programmable gate array (FPGA), and/or other suitable hardware device.

In some examples, the memory 2302 may have stored thereon machine-readable instructions (which may also be termed computer-readable instructions) that the processor 2301 may execute. The memory 2302 may be an electronic, magnetic, optical, or other physical storage device that contains or stores executable instructions. The memory 2302 may be, for example, random access memory (RAM), an Electrically Erasable Programmable Read-Only Memory (EEPROM), a storage device, an optical disc, or the like. The memory 2302, which may also be referred to as a computer-readable storage medium, may be a non-transitory machine-readable storage medium, where the term “non-transitory” does not encompass transitory propagating signals. It should be appreciated that the memory 2302 depicted in FIG. 23 may be provided as an example. Thus, the memory 2302 may or may not include additional features, and some of the features described herein may be removed and/or modified without departing from the scope of the memory 2302 outlined herein.

It should be appreciated that, and as described further below, the processing performed via the instructions on the memory 2302 may or may not be performed, in part or in total, with the aid of other information and data. Moreover, and as described further below, it should be appreciated that the processing performed via the instructions on the memory 2302 may or may not be performed, in part or in total, with the aid of or in addition to processing provided by other devices.

In some examples, and as discussed further below, the instructions on the memory 2302 may be executed alone or in combination by the processor 2301 for implementing structured polarized illumination techniques to determine and reconstruct a shape and material properties of an object.

In some examples, the instructions 2303 may provide a first anisotropic layer on top of a substrate having an alignment layer. In some examples, the anisotropic layer may have a first polarization orientation. In some examples, the anisotropic layer may be a liquid crystal (LC) layer.

In some examples, the instructions 2304 may provide a barrier layer on top of an (existing) anisotropic layer. In some examples, the barrier layer may be isotropic. In some examples, the barrier layer may be comprised of silicon dioxide (SiO2).

In some examples, the instructions 2305 may provide a second anisotropic layer on top of the barrier layer. In some examples, the anisotropic layer may have a second polarization orientation that may be different from a first polarization orientation of a (e.g., underlying) anisotropic layer that the barrier layer may rest on. In some examples, the anisotropic layer may be a liquid crystal (LC) layer.

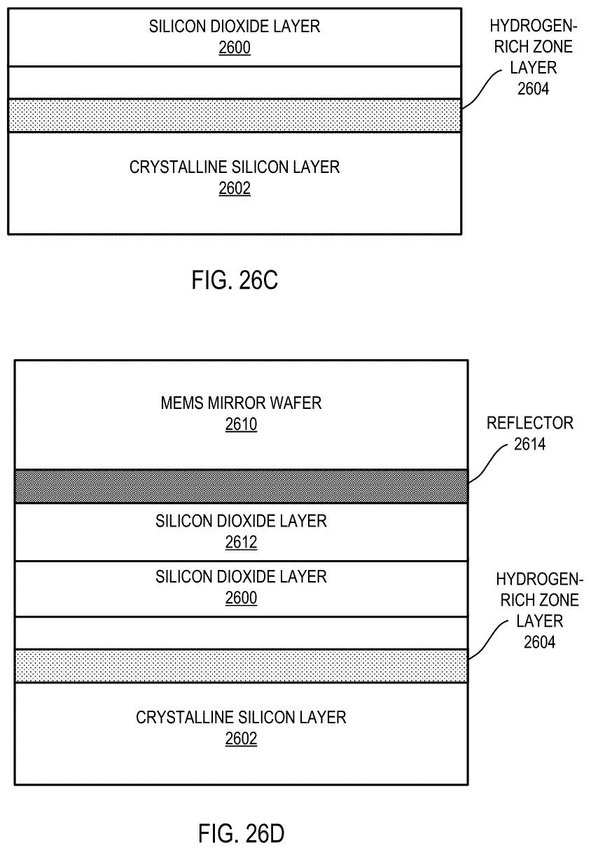

FIG. 24 illustrates a method 2400 for stacking multiple deposited anisotropic layers of a polarization grating structure using a barrier layer, according to an example. The method 2400 is provided by way of example, as there may be a variety of ways to carry out the method described herein. Each block shown in FIG. 24 may further represent one or more processes, methods, or subroutines, and at least one of the blocks may include machine-readable instructions stored on a non-transitory computer-readable medium and executed by a processor or other type of processing circuit to perform one or more operations described herein. Although the method 2400 is primarily described as being performed by system 2400 as shown in FIG. 24, the method 2400 may be executed or otherwise performed by other systems, or a combination of systems.

Reference is now made with respect to FIG. 24. At 2410, a first anisotropic layer may be provided on top of a substrate having an alignment layer. In some examples, the anisotropic layer may have a first polarization orientation. In some examples, the anisotropic layer may be a liquid crystal (LC) layer.

At 2420, a barrier layer may be provided on top of an (existing) anisotropic layer. In some examples, the barrier layer may be isotropic. In some examples, the barrier layer may be comprised of silicon dioxide (SiO2).

At 2430, a second anisotropic layer may be provided on top of the barrier layer. In some examples, the anisotropic layer may have a second polarization orientation that may be different from a first polarization orientation of a (e.g., underlying) anisotropic layer that the barrier layer may rest on. In some examples, the anisotropic layer may be a liquid crystal (LC) layer.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

A scanning MEMS mirror with a laser illuminator is a promising optical display system because of its size, relatively low power consumption, fast response times, and precise control. A potential issue with the use of MEMS mirror optical display systems is that stray light paths in the optical display systems may exist, which may negatively affect display contrast and display image quality. Some possible techniques to reduce the stray light paths may include the use of polymer or liquid crystals. However, these techniques may not be viable because they are not easy to implement with a MEMS fabrication process because of thermal issues and material differences. That is, polymer and liquid crystals may not be able to withstand the relatively high temperature applied to MEMS wafers during the MEMS fabrication process.

Another technique is to include a quarter wave plate (QWP) in the optical display systems, which may reduce stray light paths in the optical display systems and may thus improve display contrast and display image quality. Particularly, QWPs may manipulate the polarization state of light that pass through the QWPs, such as by converting linearly polarized light into circularly polarized light or vice versa. QWPs may convert the polarized light by introducing a phase difference of a quarter of a wavelength between the two orthogonal components of the incoming linearly polarized light, in which the phase difference results in the rotation of the polarization direction.

A MEMS fabrication friendly QWP design is a wire grid QWP, which may be patterned to nanometer precision. Typically, the wire grid QWPs are made from metals. However, metals, such as silver and alloys, that have good optical performance in the visible spectrum, e.g., high reflectivity and broadband operation, are typically hard to pattern and oxidize quickly.

Disclosed herein are methods for fabricating MEMS mirror devices having a wire grid QWP, in which the wire grid QWP is formed of crystalline silicon. As a result, the wire grid QWP may be patterned with high precision and may be able to withstand the relatively high temperatures applied to the MEMS mirror devices during the MEMS mirror device fabrication process. In other words, crystalline silicon may provide substantially better wire grid QWP performance as compared with conventional materials used for wire grid QWPs in MEMS mirror devices. Crystalline silicon may also provide better performance than amorphous silicon.

When silicon (Si), as a dielectric material, is used to form the wire grid QWP, both the real and imaginary parts of the dielectric constants may be important. Particularly, the imaginary parts of the dielectric constant of crystalline silicon is much lower than the imaginary parts of the dielectric constant of amorphous silicon, which leads to better QW performance. Crystalline silicon may also have a better polarization response as compared with amorphous silicon.

Through implementation of the features of the present disclosure, a MEMS mirror device may be fabricated to include a crystalline silicon QWP. In addition, the crystalline silicon QWP may be formed across an entire wafer, which contains many MEMS mirror devices, and this may simplify fabrication of the MEMS mirror device. That is, instead of forming a crystalline silicon or other material quarter wave plate on individual MEMS mirror devices, the crystalline silicon QWPs as disclosed herein, may be simultaneously created on every MEMS mirror device on a single wafer.

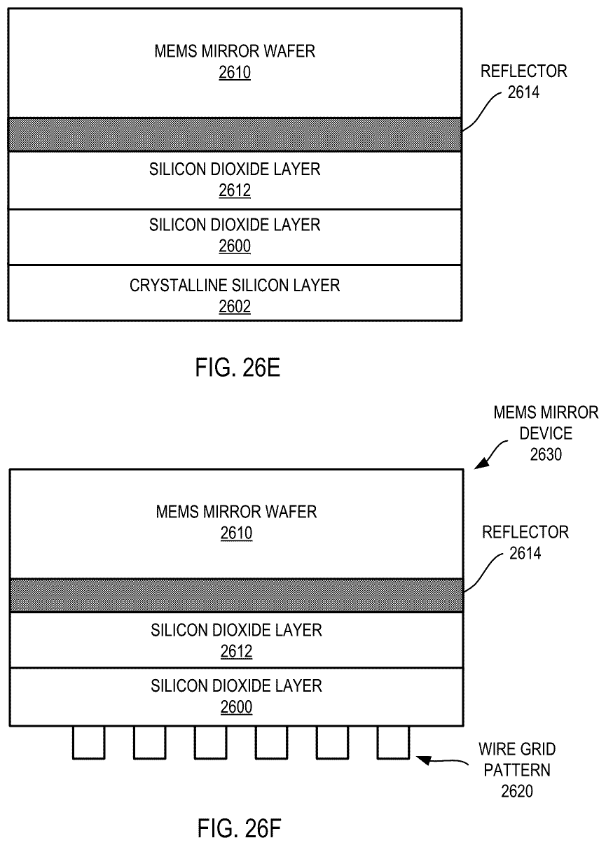

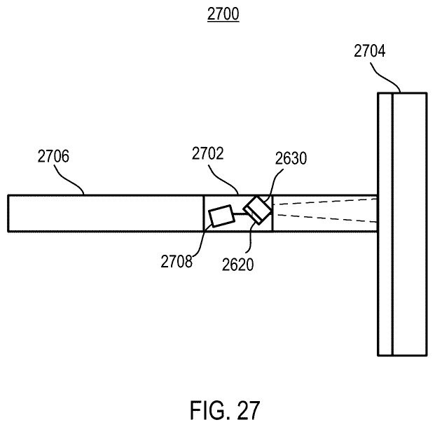

Reference is first made to FIGS. 25 and 26A-26F. FIG. 1 illustrates a flow diagram of a method 2500 of fabricating a MEMS mirror device having a wire grid quarter wave plate (QWP), according to an example. FIGS. 26A-26F, respectively, depict components of the MEMS mirror device during various fabrication phases of the MEMS mirror device, according to an example. As disclosed herein, the wire grid QWP may be formed of crystalline silicon. In addition, the MEMS mirror device may be employed, e.g., integrated, in a display of a virtual reality (VR) device, an augmented reality (AR) device, and/or a mixed reality (MR) device. These devices may provide AR and/or VR content within and associated with a real and/or virtual environment (e.g., a “metaverse”) using the MEMS mirror device disclosed herein.

As shown in FIGS. 25 and 26A, at block 2502, a silicon dioxide (SiO₂) layer 2600 may be formed on a crystalline silicon layer 2602. The silicon dioxide layer 2600 may be formed on the crystalline silicon layer 2602 through any of a number of various methods. For instance, the silicon dioxide layer 2600 may be formed through thermal oxidation, in which a crystalline silicon substrate or wafer is subjected to high temperatures in the presence of an oxidizing agent, for instance, oxygen or water vapor. The crystalline silicon substrate or wafer may be subjected to high temperatures in a high-temperature furnace or using rapid thermal processing (RTP) equipment. As the oxidation reaction continues, a layer of silicon dioxide starts to grow on the surface of the crystalline silicon substrate. After the desired thickness of the silicon dioxide layer 2600 is achieved, the crystalline silicon wafer may be subjected to an annealing step, in which any defects may be removed and the silicon dioxide layer 2600 may be stabilized.

As another example, the silicon dioxide layer 2600 may be formed on the crystalline silicon layer 2602 through an oxidation reaction, in which silicon atoms, at elevated temperatures, at the surface of the crystalline silicon substrate react with the oxygen or water vapor, forming silicon dioxide (SiO₂). As the oxidation reaction continues, a layer of silicon dioxide starts to grow on the surface of the crystalline silicon substrate. After the desired thickness of the silicon dioxide layer 2600 is achieved, the crystalline silicon wafer may be subjected to an annealing step, in which any defects may be removed and the silicon dioxide layer 2600 may be stabilized. Additional manners in which the silicon dioxide layer 2600 may be formed on the crystalline silicon layer 2602 may include chemical vapor deposition (CVD), plasma-enhanced chemical vapor deposition (PECVD), and atomic layer deposition (ALD).

At block 2504, hydrogen ions may be implanted into the crystalline silicon layer 2602 to create a hydrogen-rich zone layer 2604. The hydrogen ions may be implanted into the crystalline silicon layer 2602 through use of a technique called ion implantation, for instance, by introducing specific dopant elements or creating specific structures within the crystalline silicon layer 2602. In some examples, the hydrogen ions may be generated using an ion source, such as a plasma source or an ion accelerator, and a focused ion beam may be directed towards the crystalline silicon layer 2602. The high energy hydrogen ions penetrate the surface of the crystalline silicon layer 2602 and become embedded within the crystalline silicon layer 2602. The depth of the penetration may depend on the ion energy and an intended implantation profile. Thus, for instance, the hydrogen ions may be implanted at an intended depth in the crystalline silicon layer 2602 such that the hydrogen-rich zone layer 2604 may be formed at an intended distance from the silicon dioxide layer 2600.

At block 2506, the silicon dioxide layer 2600 may be trimmed as shown in FIG. 26C. The silicon dioxide layer 2600 may be trimmed to have a predefined thickness. For instance, the silicon dioxide layer 2600 may be trimmed to have a thickness that is about half of a spacer thickness that MEMS mirror device is to have when fabricated. By way of particular example, the silicon dioxide layer 2600 may be trimmed to have a thickness of about 38 nm. In some examples, the silicon dioxide layer 2600 may initially be formed on the crystalline silicon layer 2602 to have a thickness that is greater than 40 nm, which may be beneficial in the implanting the hydrogen ions into the crystalline silicon layer 2602 at block 2504.

The silicon dioxide layer 2600 may be trimmed through any suitable trimming process including, wet etching, dry etching, laser trimming, chemical-mechanical polishing, etc. The choice of the trimming method may depend on factors such as the desired precision and the area of trimming.

At block 2508, a MEMS mirror wafer 2610 may be bonded onto the silicon dioxide layer 2600 as shown in FIG. 26D. The MEMS mirror wafer 2610 may be fusion bonded, which may also be termed wafer bonding or direct wafer bonding, to the silicon dioxide layer 2600. As shown, the MEMS mirror wafer 2610 may also include a silicon dioxide layer 2612 and a reflector 2614. The reflector 2614 may be formed of aluminum, silver, and/or the like. In addition, the MEMS mirror wafer 2610 may be fabricated prior to being bonded to the silicon dioxide layer 2600 or may be fabricated after the crystalline silicon wire grid QWP is fabricated.

At block 2510, thermal energy may be applied onto the MEMS mirror wafer 2610, the silicon dioxide layers 2600, 2612, and the crystalline silicon layer 2602. For instance, the stack of components shown in FIG. 26D may be placed in an oven or a furnace and the thermal energy may be applied at a sufficiently high temperature to anneal and fracture the hydrogen-rich zone layer 2604. By way of example, the stack of components may be annealed at a temperature of around 500° C. or higher. An example of the stack of components with the portion of the crystalline silicon layer 2602 at the hydrogen-rich zone layer 2604 being fractured and removed is shown in FIG. 26E. In some examples, the crystalline silicon layer 2602 may be trimmed to a predefined thickness following application of the thermal energy onto the stack of components. The predefined thickness may correspond to a thickness at which performance of the wire grid QWP formed from the crystalline silicon layer 2602 may be maximized or optimized. The predefined thickness may vary depending on various aspects of the system into which the MEMS mirror device is to be employed, such as the type of illumination source, the image quality of images to be displayed, etc. Additional factors that may be considered in determining the dimensions, e.g., the thickness and the width of the wire grid, may include the wavelength(s) of the illumination light, angle of deflection of the MEMS mirror wafer 2610, etc.

At block 2512, the crystalline silicon layer 2602 may be etched into a wire grid pattern 2620 as shown in FIG. 26F. The wire grid pattern 2620 is to function as a QWP and may thus be termed a wire grid QWP 2620. The crystalline silicon layer 2602 may be etched using chemical or plasma-based etching techniques. For instance, the crystalline silicon layer 2602 may be etched using wet etching or dry etching.

According to examples, the crystalline silicon layer 2602 may be etched to have a predefined configuration and dimensions. The predefined configuration and dimensions may correspond to a configuration and dimensions at which performance of the wire grid QWP 2620 formed from the crystalline silicon layer 2602 may be maximized or optimized. The predefined configuration and dimension may also vary depending on various aspects of the system into which the MEMS mirror device is to be employed.

According to examples, the wire grid QWP 2620 may be formed across an entire or a substantial portion of the MEMS mirror wafer 2610 and may thus be formed to function as a wire grid QWP 2620 for the mirrors across the entire or a substantial portion of the MEMS mirror wafer 2610. For instance, the wire grid QWP 2620 may be formed across the entire MEMS mirror wafer 2610, which contains many MEMS mirror devices 2630, and this may simplify fabrication of the MEMS mirror device 2630. That is, instead of forming or depositing a crystalline silicon or other material wire grid QWP 2620 on individual MEMS mirror devices, the crystalline silicon wire grid QWPs described herein may simultaneously be created on every MEMS mirror device 2630 on a single wafer.

In some examples, following the formation of the wire grid pattern 2620 as shown in FIG. 26F, some additional operations may be performed on the MEMS mirror device 2630. The additional operations may include the definition of MEMS mirror flexures, patterning of piezoelectric or electrostatic driving structures, metal deposition and patterning to provide electrical contact to the driving structures, removal of silicon material under the MEMS mirror device 2630, etc.

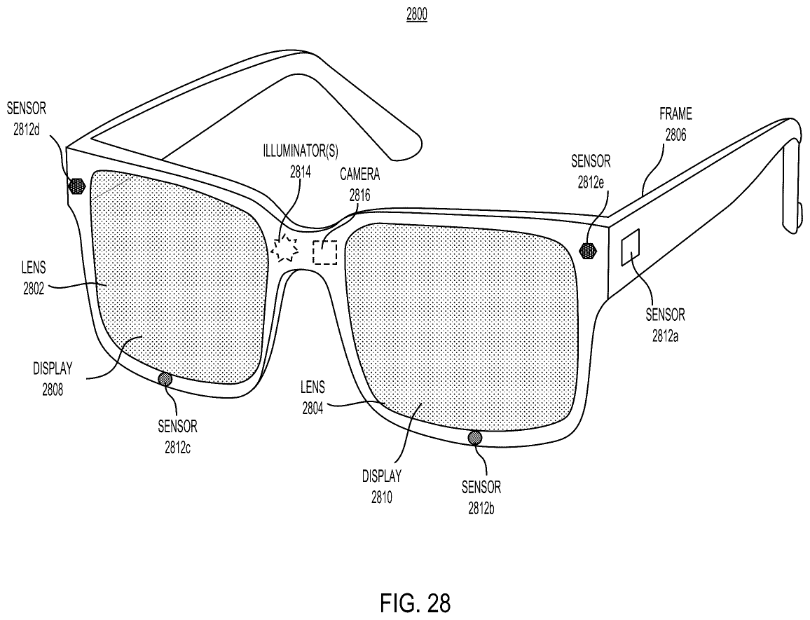

FIG. 27 illustrates a schematic diagram of a wearable device having display components 2702 positioned to direct light onto a display 2704, in which the display components 2702 include a MEMS mirror device 2630 having a crystalline silicon wire grid QWP 2620, according to an example. According to examples, the wearable device 2700 may be a wearable eyewear, a wearable headset, smartglasses, eyeglasses, and/or the like.

The wearable device 2700 may include a display 2704 and a temple arm 2706. The inside of a left temple arm 2706 and a left display 2704 are shown. Although not shown, it should be understood that the wearable device 2700 may also include a right temple arm and a right display. In addition, the temple arms and the displays may be mounted to a frame to enable a user to wear the wearable device 2700 on the user's face such that the displays 2704 may be positioned in front of the user's eyes. Display components 2702 may similarly be provided on the right temple arm and the right display 2704 may be configured to receive and display images from the display components 2702 on the right temple arm.

The display components 2702 may include a light source 2708, such as a laser beam source, that may direct light onto the MEMS mirror device 2630 having the wire grid QWP 2620. The MEMS mirror device 2630 may direct the light onto the display 2704. Particularly, the display 2704 may include optical elements that enable the light from the MEMS mirror device 2630 to be displayed on the display 2704. The optical elements may include lenses, optical waveguides, mirrors, and/or the like. In some examples, the display 2704 may be transparent such that a user may see through the display 2704. In these examples, the display 2704 may display augmented reality objects on the display 2704.

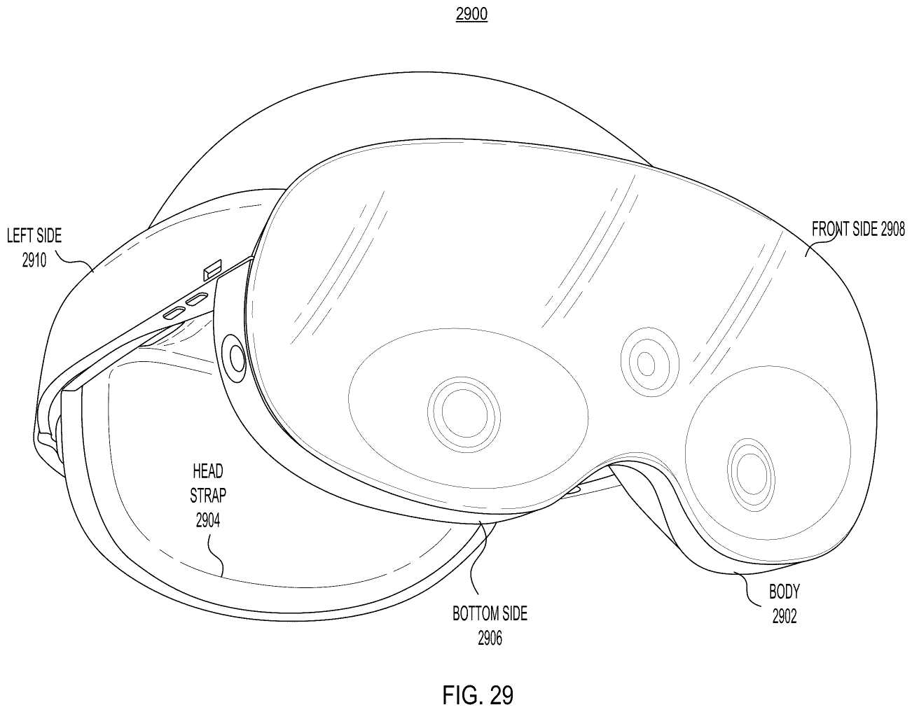

FIG. 28 illustrates a perspective view of a wearable device 2800, such as a near-eye display, in the form of a pair of smartglasses, glasses, or other similar eyewear, according to an example. In some examples, the wearable device 2800 may be a specific implementation of the wearable device 2700 of FIG. 27, and may be configured to operate as a virtual reality display, an augmented reality display, and/or a mixed reality display. In some examples, the wearable device 2800 may be eyewear, in which a user of the wearable device 2800 may see through lenses 2802, 2804 in the wearable device 2800. The lenses 2802, 2804 may be equivalent to the display discussed herein. The wearable device 2800 may also include the display components 2702, including the MEMS mirror device 2630 having the wire grid QWP 2620 as discussed herein.

In some examples, the wearable device 2800 may include a frame 2806 and displays 2808, 2810. In some examples, the displays 2808, 2810 may be configured to present media or other content to a user. In some examples, the display components may output light onto the displays 2808, 2810 to cause objects to be displayed on the displays 2808, 2810. In some examples, the displays 2808, 2810 may also include any number of optical components, such as waveguides, gratings, lenses, mirrors, etc.

In some examples, the wearable device 2800 may further include various sensors 2812a-2812e on or within a frame 2806. In some examples, the various sensors 2812a-2812e may include any number of depth sensors, motion sensors, position sensors, inertial sensors, and/or ambient light sensors, as shown. In some examples, the various sensors 2812a-2812e may include any number of image sensors configured to generate image data representing different fields of views in one or more different directions. In some examples, the various sensors 2812a-2812e may be used as input devices to control or influence the displayed content of the wearable device 2800, and/or to provide an interactive virtual reality (VR), augmented reality (AR), and/or mixed reality (MR) experience to a user of the wearable device 2800. In some examples, the various sensors 2812a-2812e may also be used for stereoscopic imaging or other similar application.

In some examples, the wearable device 2800 may further include one or more illuminators 2814 to project light into a physical environment. The projected light may be associated with different frequency bands (e.g., visible light, infra-red light, ultra-violet light, etc.), and may serve various purposes. In some examples, the one or more illuminator(s) 2814 may be used as locators.

In some examples, the wearable device 2800 may also include a camera 2816 or other image capture unit. The camera 2816 may capture images of the physical environment in the field of view of the camera 2816. In some instances, the captured images may be processed, for example, by a virtual reality engine (not shown) to add virtual objects to the captured images or modify physical objects in the captured images, and the processed images may be displayed to the user by the displays 2808, 2810 for augmented reality (AR) and/or mixed reality (MR) applications.

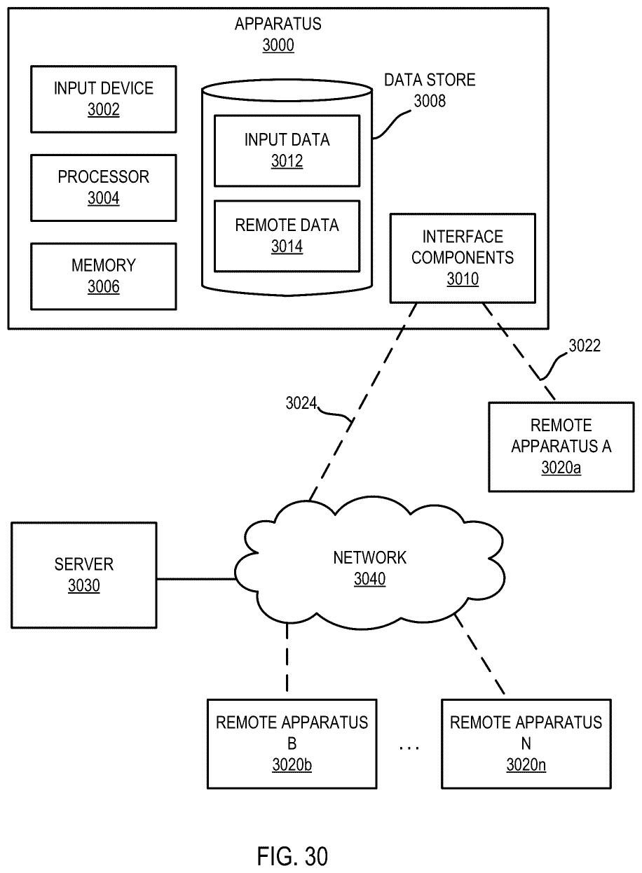

FIG. 29 illustrates a perspective view of a near-eye display device in the form of a head-mounted display (HMD) device 2900, according to an example. The HMD device 2900 may be a specific implementation of the wearable device 2600 of FIG. 26, and may be configured to operate as a virtual reality display, an augmented reality display, and/or a mixed reality display. The HMD device 2900 may also include the display components 2702, including the MEMS mirror device 2630 having the wire grid QWP 2620 as discussed herein.

As shown, the HMD device 2900 may include a body 2902 and a head strap 2904. The HMD device 2900 is also depicted as including a bottom side 2906, a front side 2908, and a left side 2910 of the body 2920 in the perspective view. In some examples, the head strap 2904 may have an adjustable or extendible length. In particular, in some examples, there may be a sufficient space between the body 2902 and the head strap 2904 of the HMD device 2900 for allowing a user to mount the HMD device 2900 onto the user's head. For example, the length of the head strap 2904 may be adjustable to accommodate a range of user head sizes. In some examples, the HMD device 2900 may include additional, fewer, and/or different components.

In some examples, the HMD device 2900 may present, to a user, media or other digital content including virtual and/or augmented views of a physical, real-world environment with computer-generated elements. Examples of the media or digital content presented by the HMD device 2900 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 29) enclosed in the body 2902 of the HMD device 2900. The display assemblies may be positioned inside of the body 2902 and may include the display components 2702 including the MEMS mirror device 2630 having the crystalline silicon wire grid QWP 2620 as discussed herein.

In some examples, the HMD device 2900 may include various sensors (not shown), such as depth sensors, motion sensors, position sensors, and/or eye tracking sensors. Some of these sensors may use any number of structured or unstructured light patterns for sensing purposes. In some examples, the HMD device 2900 may include an input/output interface (not shown) for communicating with a console. In some examples, the HMD device 2900 may include a virtual reality engine (not shown), that may execute applications within the HMD device 2900 and receive depth information, position information, acceleration information, velocity information, predicted future positions, or any combination thereof of the HMD device 2900 from the various sensors.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

Disclosed herein are apparatuses and methods for syncing data across multiple apparatuses in a secure and efficient manner. Particularly, a processor may determine that an input data has been received from or collected by an input device of an apparatus and may determine that the input data is to be synced with data on a remote apparatus. The processor may also encrypt the input data based on a determination that the input data is to be synced with data on the remote apparatus and may output the encrypted input data. The processor may output the encrypted input data directly to the remote apparatus via a local connection, such as a Bluetooth™ connection, a WiFi connection, or the like. In addition, or alternatively, the processor may output the encrypted input data to a server from which the remote apparatus may retrieve the encrypted input data.

In one regard, the processor may determine whether the input data is to be synced and may output the input data based on a determination that the input data is to be synced. As a result, the processor may not output all of the input data, but instead, may output certain types of input data. This may reduce the amount of data outputted, which may improve the battery life of the apparatus. In addition, the processor may encrypt the input data in a manner that may prevent the server from being able to decrypt the input data and thus, the input data may be passed through the server to the remote apparatus without the server identifying the contents of the input data.

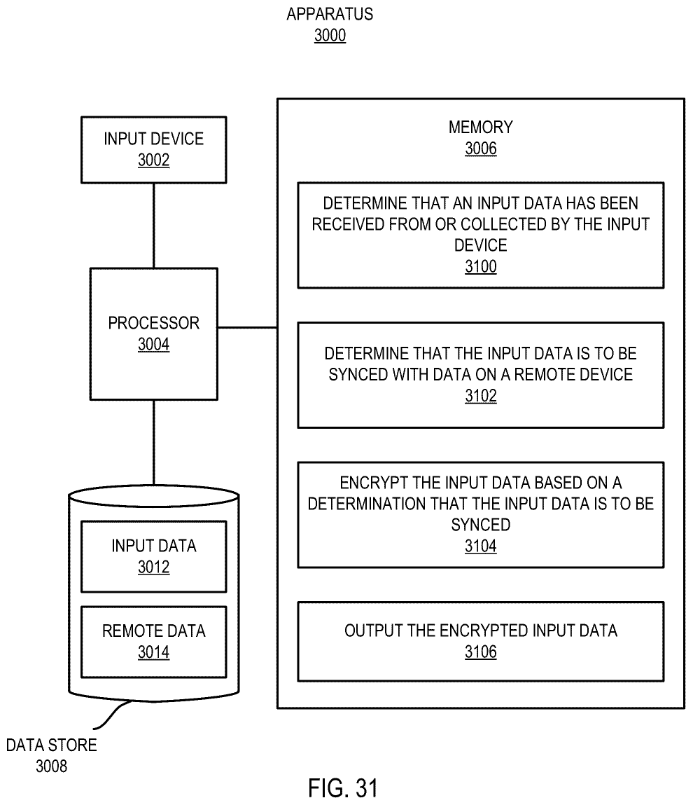

FIG. 30 illustrates a block diagram of an environment in which an apparatus 3000 may send and/or receive data to be synced across multiple apparatuses 3020a-3020n, in accordance with an example of the present disclosure. The apparatus 3000 may be a smart device, such as smartglasses, a virtual reality (VR) headset, an augmented reality (AR) headset, a smartwatch, a smartphone, a tablet computer, a wristband, and/or the like. In any of these examples, the apparatus 3000 may include an input device 3002, a processor 3004, a memory 3006, and a data store 3008.

As also shown in FIG. 30, the apparatus 3000 may communicate with one or more of the remote apparatuses 3020a-3020n via interface components 3010. The variable “n” may represent a value that is greater than one. The interface components 3010 may include hardware and/or software that may enable communication of data between the apparatus 3000 and the remote apparatuses 3020a-3020n. The remote apparatuses 3020a-3020n may include similar interface components. For instance, the interface components 3010 may enable direct wireless communication with a remote apparatus 3020a as denoted by the dashed line 3022. The wireless communication may be made through a Bluetooth™ connection with the remote apparatus 3020a, a WiFi connection with the remote apparatus 3020a, or the like.

In addition, the interface components 3010 may enable the apparatus 3000 to communicate to a server 3030 via a network 3040, which may be the Internet and/or a combination of the Internet and other networks. The communication between the apparatus 3000 and the network 3040 is denoted by the dashed line 3024. In these examples, the interface components 3010 may enable the apparatus 3000 to communicate to access points, gateways, etc., through a Bluetooth™ connection, a WiFi connection, an Ethernet connection, etc. The interface components 3010 may additionally or alternatively include hardware and/or software to enable the apparatus 3000 to communicate to the network 3040 via a cellular connection.

The remote apparatuses 3020a-3020n may each be a smart device, such as smartglasses, a VR headset, an AR headset, a smartwatch, a smartphone, a tablet computer, and/or the like. In addition, each of the remote apparatuses 3020a-3020n may include components similar to those discussed with respect to the apparatus 3000. In this regard, the remote apparatuses 3020a-3020n may communicate with other remote apparatuses 3020a-3020n and/or the server 3030 in manners similar to those discussed above with respect to the apparatus 3000.

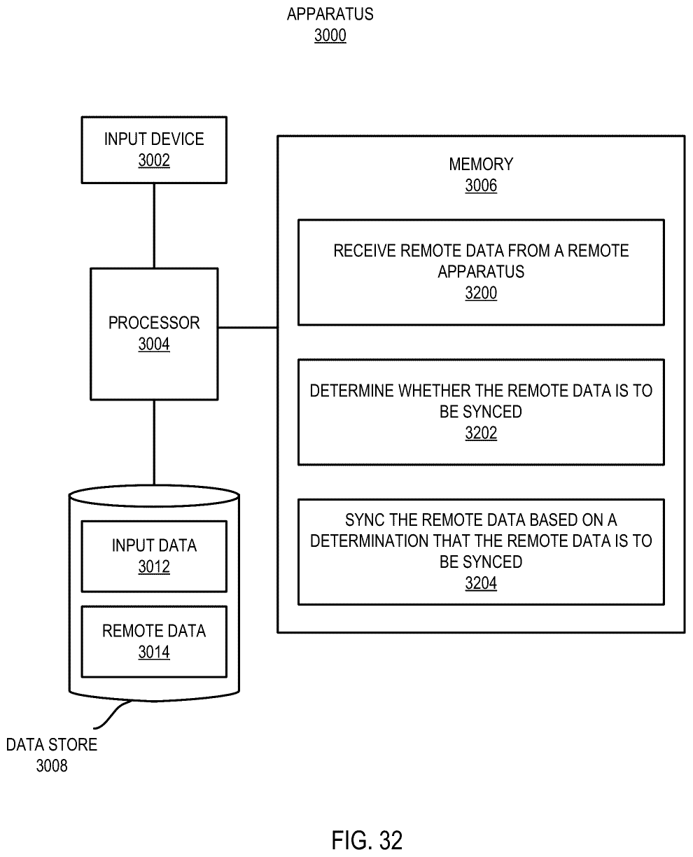

FIG. 31 illustrates a block diagram of the apparatus 3000 depicted in FIG. 30, in accordance with an example of the present disclosure. The input device 3002 may be any suitable type of device through which a user may input instructions or data and/or interact with the apparatus 3000. For instance, the input device 3002 may include a touchscreen display, a microphone, a touchpad, a mouse, a camera, etc. By way of example, a user may input instructions to the apparatus 3000 through a voice command via the microphone, a gesture command via the camera, and/or a touch command via the touchscreen display.

The input device 3002 may additionally or alternatively include any suitable device that may track a feature of the apparatus 3000 and/or a user of the apparatus 3000. For instance, the input device 3002 may include a sensor, a global positioning system device, a step counter, etc. By way of particular example, the input device 3002 may track a health-related condition of the user, such as the user's heartrate, blood pressure, movements, steps, etc.

The processor 3004 may perform various processing operations and may control operations of various components of the apparatus 3000. The processor 3004 may be a semiconductor-based microprocessor, a central processing unit (CPU), an application-specific integrated circuit (ASIC), a field-programmable gate array (FPGA), and/or other hardware device. The processor 3004 may be programmed with software and/or firmware that the processor 3004 may execute to control operations of the components of the apparatus 3000.

The memory 3006, which may also be termed a computer-readable medium 3006, may be an electronic, magnetic, optical, or other physical storage device that contains or stores executable instructions 3100-3106. The memory 3006 may be, for example, Random Access memory (RAM), an Electrically Erasable Programmable Read-Only Memory (EEPROM), a storage device, or an optical disc. For instance, the memory 3006 may have stored thereon instructions that the processor 3004 may fetch and execute. The data store 3008 may also be a computer-readable medium similar to the memory 3006. In some examples, the data store 3008 and the memory 3006 may be the same component.

The processor 3004 may execute the instructions 3100 to determine that an input data 3012 has been received from or collected by the input device 3002. The input data 3012 may be an instruction that a user has inputted to the apparatus 3000 through the input device 3002. For instance, the input data 3012 may include an instruction by a user to change a setting on the apparatus 3000, such as a language used by the apparatus 3000 to communicate with the user, a gender of a user assistant voice on the apparatus 3000, a background color scheme of images displayed on the apparatus 3000, a volume setting of the apparatus 3000, and/or the like. The input data 3012 may also or alternatively include inputs to another device, such as taking an action from one device to another device, synchronizing alerts between devices, identifying locations of devices on other devices, etc.

By way of particular example, the apparatus 3000 may be a smartphone and the remote apparatus 3020a may be a pair of smartglasses. In this example, a user of the apparatus 3000 may set a theme or interface setting of the apparatus 3000 to a certain type of theme or interface setting. For instance, the user may set the apparatus 3000 to use a female voice when communicating with the user via audio. In addition, by syncing such input data 3012 on the remote apparatus 3020a, the remote apparatus 3020a may provide a backup location for storage of the input data 3012.

In addition, or as other examples, the input data 3012 may be data pertaining to a tracked feature of the apparatus 3000 and/or a user of the apparatus 3000. The tracked feature may include a geographic location of the apparatus 3000 as determined by a GPS device, a number of steps that a user of the apparatus 3000 has taken over a certain time period, the user's heartrate, the user's blood pressure, the estimated amount of calories that the user has burned over a certain time period, etc. As an example, the remote apparatus 3020a may be used to identify the location of the apparatus 3000 using the input data 3012. As another example, the input data 3012 may be data pertaining to well-being content, such as meditation music/videos, meditation podcasts, success stories, etc., that the user may listen to or watch on their devices. As a further example, the input data 3012 may be data pertaining to a user's audio journey, e.g., a user may say something as a way to reflect on their day on the apparatus 3000.

The processor 3004 may execute the instructions 3102 to determine that the input data 3012 is to be synced with data on a remote apparatus 3020a. The processor 3004 may determine whether the input data 3012 includes a type of data that is to be synced with the data on the remote apparatus 3020a. For instance, a list of the types of data that are to be synced with the data on a remote apparatus 3020a or on multiple remote apparatuses 3020a-3020n may be stored in the data store 3008. The types of data that are to be synced with the data on the remote apparatus(es) 3020a-3020n may include any of the types of data discussed above and may be stored in a look-up table or other suitable format. The types of data that are not to be synced may include types of data that may be specific to the apparatus 3000 and that may thus not be applicable to the remote apparatus(es). In some examples, instead of the types of data that are to be synced being stored in the data store 3008, the types of data that are not to be synced may be stored in the data store 3008.

In addition, the processor 3004 may determine the type of the input data 3012 and may compare that type against the list of the types of data. Based on the comparison, the processor 3004 may determine that the input data 3012 is or is not to be synced with the data on the remote apparatus 3020a. That is, based on a determination that the input data 3012 includes a type of data that is to be synced with the data on the remote apparatus 3020a, the processor 3004 may determine that the input data 3012 is to be synced with the data on the remote apparatus 3020a. However, based on a determination that the input data 3012 does not include a type of data that is to be synced with the data on the remote apparatus 3020a, the processor 3004 may determine that the input data 3012 is not to be synced with the data on the remote apparatus 3020a.

In addition, or alternatively, to determine whether the input data 3012 is to be synced with the data on the remote apparatus 3020a, the processor 3004 may determine whether the input data 3012 includes data that has been changed from a prior synchronization event. In other words, the processor 3004 may determine whether the input data 3012 matches a previously stored input data 3012 or differs from a previously stored input data 3012. By way of example in which the input data 3012 is a voice assistant setting, the processor 3004 may determine whether the input data 3012 is a change to the voice assistant setting.

The processor 3004 may determine that the input data 3012 is to be synced with the remote apparatus 3020a based on a determination that the input data 3012 includes data that has been changed from the prior synchronization event. In some examples, the processor 3004 may determine that the input data 3012 is to be synced based on both a determination that the input data 3012 has been changed and is a type of data that is to be synced. However, based on a determination that the input data 3012 is not data that has been changed and/or does not match a type of data that is to be synced, the processor 3004 may determine that the input data 3012 is not to be synced with the remote apparatus 3020a.

The processor 3004 may execute the instructions 3104 to encrypt the input data 3012 based on a determination that the input data 3012 is to be synced with the data on the remote apparatus 3020a. The processor 3004 may employ any suitable encryption technique to encrypt the input data 3012. For instance, the processor 3004 may employ an end-to-end encryption (E2EE) method, such as, RSA, AES, Elliptic Curve Cryptography (ECC), etc. In addition, in employing E2EE, the processor 3004 may combine both symmetric and asymmetric encryption by using a secure key exchange protocol such as Diffie-Hellman to generate and share a symmetric key. This symmetric key may be used to encrypt and decrypt the actual input data 3012. In one regard, by using E2EE to encrypt the input data 3012, the input data 3012 may be communicated to the server 3030 without the server 3030 being able to decrypt and view the input data 3012. As a result, the input data 3012 may be kept private from the server 3030.

The processor 3004 may execute the instructions 3106 to output the encrypted input data 3012. According to examples, the processor 3004 may automatically output the encrypted input data 3012 to the network 3040 via the connection 3024 when the connection 3024 between the apparatus 3000 and the network 3040 is established. In addition, the processor 3004 may address the encrypted input data 3012, which may be IP packets, to be delivered to the server 3030. In these examples, the remote apparatus(es) 3020a may obtain the encrypted input data 3012 from the server 3030 via the network 3040. As discussed herein, the input data 3012 may be encrypted using E2EE in which the remote apparatus(es) 3020a may be the opposite end of the encryption pair and thus, the server 3030 may not be able to decrypt and view the input data 3012.

In other examples, the processor 3004 may determine whether the apparatus 3000 has connected to the remote apparatus 3020a via a local connection, e.g., a Bluetooth™ or WiFi connection, and may communicate the encrypted input data 3012 to the remote apparatus 3020a based on a determination that the apparatus 3000 is connected to the remote apparatus 3020a. In these examples, the processor 3004 may wait to output the encrypted input data 3012 to the remote apparatus 3020a until the connection has been established. In other words, the processor 3004 may not broadcast the encrypted input data 3012 until and unless the connection has been established, which may conserve a battery life of the apparatus 3000.

In any of the examples discussed herein, the remote apparatus(es) 3020a-3020n that obtains the encrypted input data 3012 may update the data stored on the remote apparatus(es) 3020a-3020n with the input data 3012. Thus, for instance, the remote apparatus(es) 3020a-3020n may have common settings and/or themes as the apparatus 3000. By way of particular example, the remote apparatus(es) 3020a-3020n may have the same voice assistant settings as the apparatus 3000. As a result, the user experiences may be consistent across the apparatus 3000 and the remote apparatuses 3020a-3020n without requiring that the user manually change the settings across all of the apparatuses 3000, 3020a-3020n. Additionally, other types of data, such as a user's health condition may automatically be shared across the apparatuses 3000, 3020a-3020n.

FIG. 32 illustrates a block diagram of the apparatus 3000 depicted in FIG. 30, in accordance with an example of the present disclosure. As shown in FIG. 32, the memory 3006 may have stored thereon instructions 3200-3204 that the processor 3004 may execute when remote data 3014 is received from a remote apparatus 3020a.

The processor 3004 may execute the instructions 3200 to receive remote data 3014 from a remote apparatus 3020a. The remote data 3014 may be similar to the input data 3012, but may have been collected or received by the remote apparatus 3020a and communicated to the apparatus 3000. According to examples, the apparatus 3000 may directly receive the remote data 3014 from a remote apparatus 3020a via the local connection 3022. In other examples, the apparatus 3000 may receive the remote data 3014 from the server 3030 via the connection 3024 with the network 3040. In either of these examples, the remote apparatus 3020a may have received or collected the remote data 3014 on the remote apparatus 3020a.

In some examples, the remote apparatus 3020a may have encrypted the remote data 3014 prior to communicating the remote data 3014 to the apparatus 3000. For instance, the remote apparatus 3020a may have encrypted the remote data 3014 using an E2EE scheme. In these examples, the processor 3004 may have the decryption key and may thus decrypt the encrypted remote apparatus 3020a using the decryption key. The processor 3004 may also analyze the remote data 3014.

Particularly, the processor 3004 may execute the instructions 3202 to determine whether the remote data 3014 includes a type of data that is to be synced with data stored on the apparatus 3000, e.g., the data store 3008. For instance, the processor 3004 may determine a type of the remote data 3014 and may compare that type with the types of data that are to be synced stored on the data store 3008. The processor 3004 may determine that the remote data 3014 is to be synced based on a determination that the remote data 3014 type matches a type of data that is to be synced.

As another example, the processor 3004 may determine whether the remote data 3014 includes data that has been changed from a prior synchronization event. In other words, the processor 3004 may determine whether the remote data 3014 is an updated version of the data in a prior synchronization event. The processor 3004 may determine that the remote data 3014 is to be synced with the data stored on the apparatus 3000 based on a determination that the remote data 3014 includes data that has been changed. In some examples, the processor 3004 may compare timestamps associated with the remote data 3014 and the stored data and may determine that the remote data 3014 is to be synced if the timestamp of the remote data 3014 is later than the timestamp of the stored data. In addition, the processor 3004 may determine that the remote data 3014 is not to be synced with the stored data based on a determination that the remote data 3014 includes data that has not been changed, e.g., is the same as the stored data.

The processor 3004 may execute the instructions 3204 to sync the remote data 3014 with the data stored on the apparatus 3000 based on a determination that the remote data 3014 is to be synced. The processor 3004 may sync the remote data 3014 with the stored data by, for instance, replacing the stored data with the remote data 3014 or adding the remote data 3014 to the stored data. According to examples, the remote apparatuses 3020a-3020n may execute similar operations to sync the input data 3012 when the remote apparatuses 3020a-3020n receive the input data 3012 from the apparatus 3000.

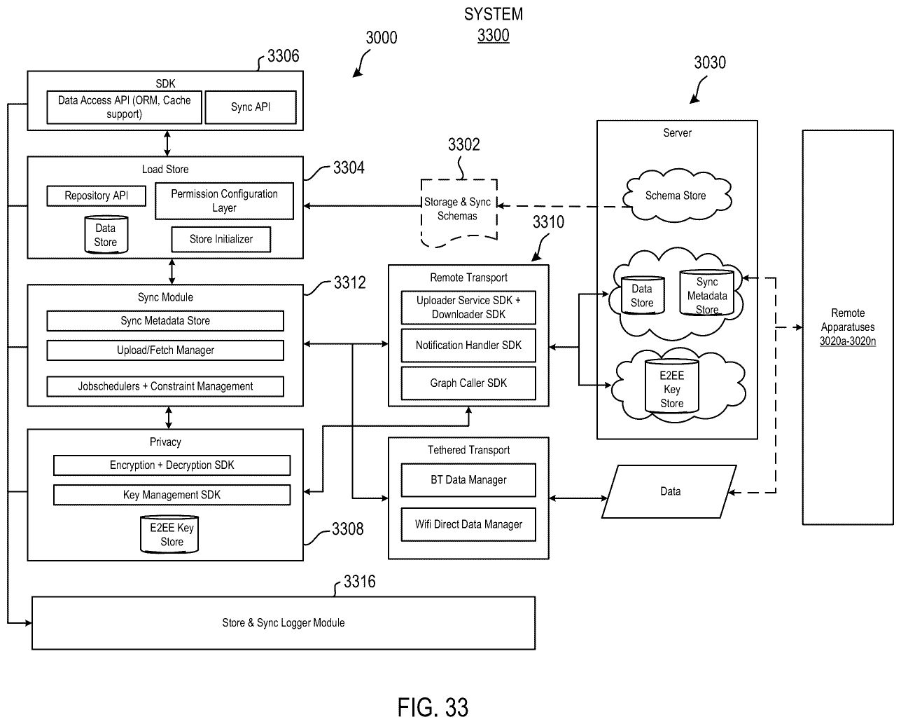

FIG. 33 illustrates a block diagram of a system 3300 that includes features of the apparatus 3000 depicted in FIGS. 30-32, in accordance with an example of the present disclosure. Generally speaking, the system 3300 illustrates features of the apparatus 3000, the server 3030, and the remote apparatuses 3020a-3020n that may enable the processor 3004 to sync input data with the remote apparatuses 3020a-3020n.

As shown, the features of the apparatus 3000 may integrate with schema management modules to use the storage and sync schemas 402 to create a local storage layer (load store 3304) for the input data 3012 that is to be synced with a remote apparatus 3020a or to sync remote data 3014 that is to be synced with data on the apparatus 3000. The processor 3004 may use a mixture of code-gen+custom code to create the ORM layer (in the SDK 3306) for clients to use to securely access their data and ensure forward and backwards compatibility. The processor 3004 may also integrate with a privacy module 3308, a transport module 3310, and a sync module 3312 to enable end-to-end encrypted data syncs across the apparatuses 3000, 3020a-3020n. The processor 3004 may further integrate with a tethered device (remote apparatus 3020a) and an untethered device (server 3030) through remote and tethered transports and may ensure eventual input data 3012 syncs. The processor 3004 may still further integrate with the server 3030, which may manage data, sync metadata, and E2EE keys. The processor 3004 may still further integrate with a store and sync logger module 3316 to ensure that consistent logging is done for all storage and sync use cases.

FIG. 33 also shows the following components:

| Components | Description |
|---|---|
| SDK 3306 | This is what the callers will integrate from their |
| | app and use to interact with the instructions. The |
| | SDK will allow callers to access their data (that |
| | may include both local and remote sources) and |
| | trigger sync mechanisms. |
| ORM schemas | Schema that defines the data models, DB tables |
| | and indices, and queries. |
| Configuration | Schema that defines the storage and sync |
| schemas | configurations such as (sync direction, how |
| | often to sync, how to handle conflicts, privacy |
| | modes, who has access to read/write data) etc. |
| Schema | A module that helps clients manage their |
| management | schemas and their evolution. |
| Local storage | A module that helps create usable Kotlin, Swift |
| code generation | and C++ code for clients to use. May be fully |
| module | auto generated or may have some custom |
| | implementations. |
| Local storage | A module that provides the APIs needed for |
| ORM | clients to access their data locally. May be a |
| | thin layer on top of the generated modules. |
| Sync module | A module that used the sync policies to determine |
| 3312 | how to remote sync the data from local storage. |
| | Also helps manage the “dirty sets” of data that |
| | need to sync and apply the “remote data” to |
| | sync local storage. Interacts with privacy and |
| | transport modules. |
| Privacy module | A module that deals with the privacy policies |
| 3308 | associated with the data. |
| Transport | A module that helps with data transport across |
| module 3310 | devices. May use both cloud frameworks as well |
| | as BT and peer to peer data transfer policies. |
| Metrics module | A module that helps log the useful metadata |
| | related to storage and sync of data types. May |
| | also have a server component to aggregate this |
| | into a helpful and usable dashboard for clients |
| | to use. |
| Tools | Server and local debug tools to help debug |
| | these complex flows. Ex., what local E2EE keys |
| | are available, when keys were last rotated, what |
| | data type was uploaded on the server at what |
| | timestamp from which device, what data type |
| | got fetched/pushed from the server to which |
| | device at what timestamp, etc. |

Schemas may enable consistency for cross platform data access. As a result, schema definitions of each data type may be available on the apparatuses 3000, 3020a-3020n. The storage ORM schemas may be used to define the data models, data access queries, etc., that a use case may need. The configuration schemas may capture the storage and sync policies for those data types such as:

| Sync Policy | Description |
|---|---|
| Security configurations | Capture the security configs like |
| | read and write permissions, TTL. |
| Privacy configurations | Determines privacy of the data, |
| | e.g., is the data going to be |
| | end-to-end encrypted at rest or not. |
| Data sync destinations | The devices and apps to which the |
| | data should get synced. |
| Data sync sources | The devices and apps from where |
| | any remote data should be fetched. |
| Scheduled sync | Constraints, transport mode, |
| configuration | cadence configurations. |
| On-demand sync | Constraints, transport mode |
| configuration | |
| Pub-sub | Capture the pub-sub model of the |
| | data such as when/how to publish |
| | data to the Drive app & when/how |
| | to wake up the app readers on |
| | remote data updates. |

According to examples, the privacy module 3308 may enable the privacy of data types that are getting synced via the server 3030 to the remote apparatuses 3020a-3020n. The privacy module 3308 may support the following modes:

| Modes | Description |
|---|---|
| No E2EE (End | This is not recommended for any data |
| to End Encryption) | type that gets synced via the server. So for |
| | data types that do allow server based sync, |
| | evaluation and an understanding as to why |
| | this mode was chosen may need to be |
| | made and exception approvals may be |
| | needed. |
| | Ex., media since the product needs to |
| | support montage and memories use |
| | cases that need server processing. |
| E2EE with device- | This enables E2EE commitment for data |
| device key | access if there are no use cases to fetch |
| management | older historical data generated on older |
| | devices on a new device. |
| | This is relevant for use cases that |
| | typically overwrite and don’t need to |
| | preserve historical data. Ex. last known |
| | device location for FindMy use case. |
| E2EE with hardware | This enables E2EE commitment for data |
| secure module based | access if there are use cases to fetch |
| key management | older historical data generated on older |
| | devices on a new device. |
| | This is relevant for use cases that |
| | typically need to preserve all the |
| | historical data and make it available |
| | for users to access later on new devices. |
| | Ex., history of all workouts, system |
| | backups etc. |

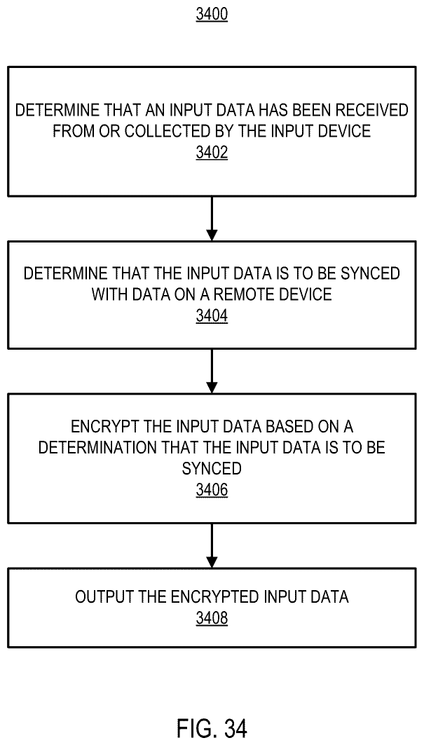

Various manners in which the processor 3004 of the apparatus 3000 may operate are discussed in greater detail with respect to the method 3400 depicted in FIG. 34. FIG. 34 illustrates a flow diagram of a method 3400 for syncing input data 3012 with data on a remote apparatus 3020a, according to an example of the present disclosure. It should be understood that the method 3400 depicted in FIG. 34 may include additional operations and that some of the operations described therein may be removed and/or modified without departing from the scope of the method 3400. The description of the method 3400 is made with reference to the features depicted in FIGS. 30-34 for purposes of illustration.

At block 3402, the processor 3004 may determine that an input data 3012 has been received from or collected by the input device 3002. The input data 3012 may be an instruction that a user has inputted to the apparatus 3000 through the input device 3002 and/or data pertaining to a tracked feature of the apparatus 3000 and/or a user of the apparatus 3000.

At block 3404, the processor 3004 may determine that the input data 3012 is to be synced with data on a remote apparatus 3020a. As discussed herein, the processor 3004 may determine that the input data 3012 is to be synced based on the type of the input data 3012 matching a certain type of data and/or based on the input data 3012 being different from data at a previous synchronization event.

At block 3406, the processor 3004 may encrypt the input data 3012 based on a determination that the input data 3012 is to be synced. The processor 3004 may encrypt the input data 3012 in any suitable manner, such as using an end-to-end scheme as discussed herein.

At block 3408, the processor 3004 may output the encrypted input data 3012. The processor 3004 may output the encrypted input data 3012 directly to the remote apparatus 3020a and/or to a server 3030 via a network 3040.

Some or all of the operations set forth in the method 3400 may be included as a utility, program, or subprogram, in any desired computer accessible medium. In addition, the method 3400 may be embodied by a computer program, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A system, comprising:
a light source to transmit an original beam of light;
a first grating to receive and diffract the original beam of light into a first light beam having a first circular polarization and a second light beam having a second circular polarization;
a second grating to receive the first light beam and the second light beam and transmit overlapping light beams towards an object;
a polarization camera to capture light reflected from the object; and
a processing unit to:
determine, based on a fringe projection analysis associated with the object, a shape of the object; and
determine, based on the fringe projection analysis associated with the object, a Mueller matrix to describe material properties of the object.

2. The system of claim 1, wherein the processing unit is further to:
determine an input Stokes vector associated with the overlapping light beams; and
determine, based on the fringe projection analysis associated with the object, an output Stokes vector,
wherein the Mueller matrix to describe material properties of the object is determined further based on the input Stokes vector and the output Stokes vector.

3. The system of claim 1, wherein the first grating and the second grating are Pancharatman-Berry (PB) gratings, and wherein the first circular polarization is a right-handed circular polarization and the second circular polarization is a left-handed circular polarization.

4. The system of claim 1, wherein the polarization camera comprises at least one unit cell of pixels comprising at least one pixel, wherein each of the at least one pixel implements a particular wire grid orientation of a polarizer array.

5. The system of claim 4, wherein a first pixel of the at least one pixel implements a wire grid orientation of 0 degrees, a second pixel of the at least one pixel implements a wire grid orientation of π/4 degrees, a third pixel of the at least one pixel implements a wire grid orientation of π/2 degrees, and a fourth pixel of the at least one pixel implements a wire grid orientation of −π/4 degrees.

6. The system of claim 1, wherein the processing unit is further to:
determine a group of pixels of the polarization camera having a same incident and scattering angle with respect to a surface normal.

7. The system of claim 1, wherein the processing unit is further to analyze, utilizing a plurality of illumination objects, the light reflected from the object to determine the fringe projection analysis associated with the object, wherein the plurality of illumination objects comprises a black illumination card having a smaller angle of incidence (AOI), a black illumination card having a larger angle of incidence (AOI), a white illumination card having the smaller angle of incidence (AOI), and white illumination card having the larger angle of incidence.

8. A method for implementing structured polarized illumination techniques to determine and reconstruct a shape and a material property of an object, comprising:
transmitting an original beam of light;
diffracting, utilizing a first grating, the original beam of light into a first light beam having a first circular polarization and a second light beam having a second circular polarization;
receiving the first light beam and the second light beam at a second grating and transmitting overlapping light beams towards the object;
capturing, utilizing a polarization camera, light reflected from the object;
determining, based on a fringe projection analysis associated with the object, the shape of the object; and
determining, based on the fringe projection analysis associated with the object, a Mueller matrix to describe the material properties of the object.

9. The method of claim 8, further comprising:
determining an input Stokes vector associated with the overlapping light beams; and
determining, based on the fringe projection analysis associated with the object, an output Stokes vector,
wherein the Mueller matrix to describe material properties of the object is determined further based on the input Stokes vector and the output Stokes vector.

10. The method of claim 8, further comprising:
determining a group of pixels of the polarization camera having a same incident and scattering angle with respect to a surface normal.

11. The method of claim 8, wherein the first grating and the second grating are Pancharatman-Berry (PB) gratings, and wherein the first circular polarization is a right-handed circular polarization and the second circular polarization is a left-handed circular polarization.

12. The method of claim 8, wherein the polarization camera comprises at least one unit cell of pixels comprising at least one pixel, wherein each of the at least one pixel implements a particular wire grid orientation of a polarizer array.

13. The method of claim 8, wherein a first pixel of the at least one pixel implements a wire grid orientation of 0 degrees, a second pixel of the at least one pixel implements a wire grid orientation of π/4 degrees, a third pixel of the at least one pixel implements a wire grid orientation of π/2 degrees, and a fourth pixel of the at least one pixel implements a wire grid orientation of −π/4 degrees.

14. The method of claim 8, further comprising:
analyzing, utilizing a plurality of illumination objects, the light reflected from the object to determine the fringe projection analysis associated with the object, wherein the plurality of illumination objects comprises a black illumination card having a smaller angle of incidence (AOI), a black illumination card having a larger angle of incidence (AOI), a white illumination card having the smaller angle of incidence (AOI), and white illumination card having the larger angle of incidence.

15. An apparatus, comprising:
a processor; and
a non-transitory computer-readable storage medium having an executable stored thereon, which when executed instructs the processor to:
determine an input Stokes vector associated with overlapping light beams from a grating;
implement a polarization camera to capture light reflected from an object;
determine, based on a fringe projection analysis associated with the object, a shape of the object;
determine, based on the fringe projection analysis associated with the object, an output Stokes vector; and
determine, based on the fringe projection analysis associated with the object, the input Stokes vector, and the output Stokes vector, a Mueller matrix to describe material properties of the object.

16. The apparatus of claim 15, wherein the executable when executed further instructs the processor to:
determine a group of pixels of the polarization camera having a same incident and scattering angle with respect to a surface normal.

17. The apparatus of claim 15, wherein the grating is a Pancharatman-Berry (PB) grating.

18. The apparatus of claim 15, wherein the executable when executed further instructs the processor to:
analyze, utilizing a plurality of illumination objects, the light reflected from the object to determine a fringe projection analysis associated with the object, wherein the plurality of illumination objects comprises a black illumination card having a smaller angle of incidence (AOI), a black illumination card having a larger angle of incidence (AOI), a white illumination card having the smaller angle of incidence (AOI), and white illumination card having the larger angle of incidence.

19. The apparatus of claim 15, wherein the polarization camera comprises at least one unit cell of pixels comprising at least one pixel, wherein each of the at least one pixel implements a particular wire grid orientation of a polarizer array.

20. The apparatus of claim 19, wherein a first pixel of the at least one pixel implements a wire grid orientation of 0 degrees, a second pixel of the at least one pixel implements a wire grid orientation of π/4 degrees, a third pixel of the at least one pixel implements a wire grid orientation of π/2 degrees, and a fourth pixel of the at least one pixel implements a wire grid orientation of −π/4 degrees.
